(19) United States
(12) Patent Application Publication
(10) Pub. No.: US 2026/0115635 A1
(43) Pub. Date: Apr. 30, 2026

(54) REFRIGERATOR AND MANIFOLD FOR WATER FILTER

(71) Applicant: Qingdao Ecopure Filter Co., Ltd., Qingdao (CN)

(72) Inventor: Zhibin Zou, Qingdao (CN)

(21) Appl. No.: 19/097,000

(22) Filed: Apr. 1, 2025

Related U.S. Application Data
(63) Continuation of application No. 29/867,637, filed on Nov. 1, 2022.

(51) Int. Cl. B01D 35/30; B01D 35/02; F25D 23/12

(52) U.S. Cl. CPC B01D 35/30; B01D 35/02; F25D 23/126; B01D 2201/4061; F25D 2323/121

(57) ABSTRACT

Manifolds for water filters and refrigerators with such manifolds. The manifold includes a channel or shaft, and a tube located within that channel or shaft. The tube has a distal end and a proximal end. The distal end of the tube includes a bridge that extends toward the inside of the tube from a distal wall portion of the tube. In exemplary embodiments, the bridge extends across the inside of the tube from one part of the distal wall to another part of the distal wall. In other exemplary embodiments, a projection extends distally from a proximal wall of the manifold toward the distal end of the tube, the projection being present at the midpoint of the distance between a point on the tube and an opposite wall.

### CROSS-REFERENCE TO RELATED APPLICATIONS

This case is a continuation of and claims priority to U.S. Ser. No. 29/867,637 (“the '637 Appl'n”) filed on 1 Nov. 2022 (Attorney Docket 38704.04318), which is incorporated by reference in its entirety. This case also claims priority to U.S. patent application Ser. No. 18/310,820 (“the '820 Appl'n”), filed on 2 May 2023 (Attorney Docket 38704.04164), which claims the benefit of U.S. Provisional Patent No. 63/339,085, filed on 6 May 2022 (Attorney Docket 38704.04093), the entire disclosures of which are fully incorporated herein by reference.

### FIELD

The present application pertains to manifolds for water filters and refrigerators with such manifolds.

### SUMMARY

An exemplary refrigerator has a manifold for a water filter positioned inside the refrigerator. The manifold includes a channel or shaft, and a tube located within that channel or shaft. The tube has a distal end and a proximal end. The distal end of the tube includes a bridge that extends toward the inside of the tube from a distal wall portion of the tube. In exemplary embodiments, the bridge extends across the inside of the tube from one part of the distal wall to another part of the distal wall.

Another exemplary refrigerator has a manifold for a water filter positioned inside the refrigerator. The manifold includes a channel or shaft, and a tube located within that channel or shaft. The tube has a distal end and a proximal end. The distal end of the tube includes at least one distal wall portion that is located farther from the proximal end than another second wall portion. Additionally, the manifold includes a bridge that extends toward the inside of the tube from the distal wall portion.

Yet another exemplary refrigerator has a manifold for a water filter positioned in an interior of the refrigerator. The manifold includes a shaft; a tube inside the shaft, the tube having a wall, a distal end, and a proximal end, the distal end of the tube having a plurality of distal wall portions that are positioned farther away from the proximal end than a plurality of intermediate wall portions; and a bridge extending toward an inside of the tube from one of the plurality of distal wall portions.

Still yet another exemplary refrigerator has a manifold for a water filter positioned in an interior of the refrigerator, the manifold including a shaft; a tube inside the shaft, the tube having a wall, a distal end, and a proximal end; and a projection extending distally toward the distal end of the tube, the projection being present at the midpoint of the distance between a point on the tube and an opposite wall.

Yet still another exemplary refrigerator has a manifold for a water filter positioned in an interior of the refrigerator, the manifold including a shaft; a tube inside the shaft, the tube having a wall; and a bridge extending from one side of the tube to the other side of the tube with a first gap between a first side of the bridge and the tube and a second gap between a second side of the bridge and the tube.

And still another exemplary refrigerator has a manifold for a water filter positioned in an interior of the refrigerator, the manifold including a shaft; a tube inside the shaft; and a piece extending into the tube to prevent a component of a filter from entering the midpoint of the tube.

An exemplary manifold includes a channel or shaft, and a tube located within that channel or shaft. The tube has a distal end and a proximal end. The distal end of the tube includes a bridge that extends toward the inside of the tube from a distal wall portion of the tube. In exemplary embodiments, the bridge extends across the inside of the tube from one part of the distal wall to another part of the distal wall.

An exemplary manifold includes a channel or shaft, and a tube located within that channel or shaft. The tube has a distal end and a proximal end. The distal end of the tube includes at least one distal wall portion that is located farther from the proximal end than another second wall portion. Additionally, the manifold includes a bridge that extends toward the inside of the tube from the distal wall portion.

Another exemplary manifold includes a shaft; a tube inside the shaft, the tube having a wall, a distal end, and a proximal end, the distal end of the tube having a plurality of distal wall portions that are positioned farther away from the proximal end than a plurality of intermediate wall portions; and a bridge extending toward an inside of the tube from one of the plurality of distal wall portions.

Still yet another exemplary manifold for a water filter includes a shaft; a tube inside the shaft, the tube having a wall, a distal end, and a proximal end; and a projection extending distally toward the distal end of the tube, the projection being present at the midpoint of the distance between a point on the tube and an opposite wall. In exemplary embodiments, the tube has central longitudinal axis, and the projection extends from one side of the tube to the other side of the tube with a gap between the central longitudinal axis of the projection and the tube.

Yet still another exemplary manifold for a water filter includes a shaft; a tube inside the shaft, the tube having a wall; and a bridge extending from one side of the tube to the other side of the tube with a first gap between a first side of the bridge and the tube and a second gap between a second side of the bridge and the tube.

And still another exemplary refrigerator has a manifold for a water filter positioned in an interior of the refrigerator, the manifold including a shaft; a tube inside the shaft; and a piece extending into the tube to prevent a component of a filter from entering the midpoint of the tube.

An exemplary manifold for a water filter includes a shaft; a tube inside the shaft and having a central longitudinal axis; and a piece extending into the tube to prevent a component of a filter from entering the region of the tube's central longitudinal axis. In some exemplary embodiments, a piece extends into the tube to prevent a component of a filter from entering a point of the region of the tube's central longitudinal axis. In some exemplary embodiments, a piece extends into the tube to prevent a component of a filter from entering any portion of the region of the tube's central longitudinal axis.

In exemplary embodiments, the piece extends from one side of the tube to the other side of the tube with a first gap at the midpoint of the bridge and the tube, and the first gap is configured to prevent a component of a filter from entering into it. In other exemplary embodiments, the first gap has a minimum dimension to prevent a component of a filter from entering into the first gap. In yet further embodiments, the tube has a wall, a distal end, and a proximal end, the distal end of the tube has at least a distal wall portion that is positioned farther away from the proximal end than another second wall portion, and the piece extends toward the inside of the tube from the distal wall portions along the length of the tube.

Exemplary manifolds include first and second distal wall portions positioned across from each other, with intermediate wall portions positioned therebetween, and with the bridge extending toward an inside of the tube from the first distal wall portion, across the inside of the tube, and to the second distal wall portion.

In exemplary manifolds, the bridge extends toward an inside of the tube from the first distal wall portion, across the inside of the tube, and toward the second distal wall portion; and the bridge extends toward an inside of the tube from the second distal wall portion, across the inside of the tube, and toward the first distal wall portion.

According to a first aspect, a filter structure comprises a filtering member; a housing comprising a housing body comprising an opening portion and a housing cap coupled to the opening portion of the housing body; and an upper supporter coupled to the filtering member and disposed on an inner surface of the housing cap. The upper supporter comprises a supporter extending portion extending from the upper supporter portion, the supporter extending portion comprises a filter inlet flow path, a projection portion formed on an inner surface of the filter inlet flow path, and a filter outlet flow path separated from the first filter inlet flow path in the supporter extending portion.

In a second aspect, a filter structure comprises the filter structure according to the previous aspect, wherein the housing cap is coupled to the opening of the housing body by ultrasonic welding or an adhesive.

In a third aspect, a filter structure comprises the filter structure according to any previous aspect, wherein the housing further comprises a connector positioned between and coupled to each of the housing body and the housing cap.

In a fourth aspect, a filter structure comprises the filter structure according to the third aspect, wherein the filtering member is positioned within the housing body, the connector, and the housing cap.

In a fifth aspect, a filter structure comprises the filter structure according to the third aspect, wherein the filtering member is positioned within the connector and the housing cap and is not positioned within the housing body.

In a sixth aspect, a filter structure comprises the filter structure according to the fifth aspect, wherein a spacer is positioned within the housing body to position the filtering member within the connector.

In a seventh aspect, a filter structure comprises the filter structure according to any of the first or second aspects, wherein the housing cap is directly coupled to the opening of the housing body.

In an eighth aspect, a filter structure comprises the filter structure according to the seventh aspect, wherein the filtering member is positioned within the housing body.

In a ninth aspect, a filter structure comprises the filter structure according to any previous aspect, wherein the housing cap comprises an accommodating portion for receiving the filtering member.

In a tenth aspect, a filter structure comprises the filter structure according to any previous aspect, wherein the upper supporter further comprises a supporter accommodating portion configured to receive accommodate an end of the filtering member.

In an eleventh aspect, a filter structure comprises the filter structure according to any previous aspect, wherein the supporter accommodating portion is positioned within the housing cap.

In a thirteenth aspect, a filter structure comprises the filter structure according to any previous aspect, wherein the supporter accommodating portion extends into the housing body.

In a fourteenth aspect, a filter structure comprises the filter structure according to any previous aspect, wherein a circumferential edge of the supporter accommodating portion tapers from a side proximate the filtering member to a side from which the supporter extending portion extends.

In a fifteenth aspect, a filter structure comprises the filter structure according to any of the first through thirteenth aspects, wherein the supporter accommodating portion has an outer circumference that is substantially constant, and wherein the supporter extending portion extends from an upper surface of the supporter accommodating portion.

In a sixteenth, a filter structure comprises the filter structure according to any previous aspect, wherein a gasket is positioned between the supporter extending portion and the housing cap.

In a seventeenth aspect, a filter structure comprises the filter structure according to the sixteenth aspect, wherein the gasket is formed of a material that blocks the flow of water.

In an eighteenth aspect, a filter structure comprises the filter structure according to the sixteenth aspect, wherein the gasket is formed from a porous material.

In a nineteenth aspect, a filter structure comprises the filter structure according to any of the sixteenth through eighteenth aspects, wherein the gasket includes one or more flow paths to enable water to flow through the gasket.

According a twentieth aspect, a filter structure comprises a filtering member; a housing comprising a first half and a second half, each of the first half and the second half comprising a housing body portion and a housing cap portion, wherein the housing encloses the filtering member; and an upper supporter coupled to the filtering member. The upper supporter comprises a supporter extending portion extending from the upper supporter portion, the supporter extending portion comprises a filter inlet flow path, a projection portion formed on an inner surface of the filter inlet flow path, and a filter outlet flow path separated from the first filter inlet flow path in the supporter extending portion.

In a twenty-first aspect, a filter structure comprises the filter structure according to the twentieth aspect, wherein the first half of the housing is coupled to the second half of the housing by ultrasonic welding or an adhesive.

In a twenty-second aspect, a filter structure comprises the filter structure according to the twentieth or twenty-first aspects, wherein the upper supporter further comprises a supporter accommodating portion configured to receive accommodate an end of the filtering member.

In a twenty-third aspect, a filter structure comprises the filter structure according to any of the twentieth through twenty-second aspects, wherein the supporter accommodating portion has an outer circumference that is substantially constant, and wherein the supporter extending portion extends from an upper surface of the supporter accommodating portion.

In a twenty-fourth aspect, a filter structure comprises the filter structure according to any of the twentieth through twenty-third aspects, wherein a gasket is positioned between the supporter extending portion and the housing cap.

In a twenty-fifth aspect, a filter structure comprises the filter structure according to the twenty-fourth aspect, wherein the gasket is formed of a material that blocks the flow of water.

In a twenty-sixth aspect, a filter structure comprises the filter structure according to the twenty-fourth aspect, wherein the gasket is formed from a porous material.

In a twenty-seventh aspect, a filter structure comprises the filter structure according to any of the twenty-fourth through twenty-sixth aspects, wherein the gasket includes one or more flow paths to enable water to flow through the gasket.

In a twenty-eighth aspect, a filter structure comprises the filter structure according to any of the preceding aspects, wherein the supporter extending portion comprises a first connecting portion.

In a twenty-ninth aspect, a filter structure comprises the filter structure according to the twenty-eighth aspect, wherein the first connecting portion is a projection that does not include a recess from an upper end of the supporter extending portion.

In a thirtieth aspect, a filter structure comprises the filter structure according to the twenty-eighth or twenty-ninth aspects, wherein the first connecting portion is asymmetrical with respect to the projecting portion.

In a thirty-first aspect, a filter structure comprises the filter structure according to any of the twenty-eighth through thirtieth aspects, wherein the projecting portion does not extend from the first connecting portion.

In a thirty-second aspect, a filter structure comprises the filter structure according to any of the twenty-eight through thirty-first aspects, wherein the projecting portion extends between the first connecting portion.

In a thirty-third aspect, a filter structure comprises the filter structure according to any of the previous aspects, wherein the projecting portion comprises a plurality of pins.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

FIG. 1 is a front view of a refrigerator illustrating an exemplary placement of a manifold within the interior (FIG. 8 from the '637 Appl'n).

FIG. 2 is a front view of another refrigerator illustrating another exemplary placement of the manifold within the interior (FIG. 11 from the '637 Appl'n).

FIG. 3 is a perspective view of a manifold, illustrating the internal components including a channel, a tube, the tube distal end, and a bridge (portion of FIG. 10 from the '637 Appl'n).

FIG. 4 is another perspective view of the manifold, illustrating the internal components including a channel, a tube, the tube distal end, and a bridge (portion of FIG. 13 from the '637 Appl'n).

FIG. 5 is another perspective view of a the manifold, illustrating the internal components including a channel, a tube, the tube distal end, and a bridge (portion of FIG. 14 from the '637 Appl'n).

FIG. 6 is another perspective view of a the manifold, illustrating the internal components including a channel, a tube, the tube distal end, and a bridge (portion of FIG. 16 from the '637 Appl'n).

FIG. 7 is another perspective view of a the manifold, illustrating the internal components including a channel, a tube, the tube distal end, and a bridge (portion of FIG. 21 from the '637 Appl'n).

FIGS. 8, 9, and 10 are other perspective views of a the manifold, illustrating the internal components including a channel, a tube, the tube distal end, and a bridge (portions of FIGS. 25, 27, and 32 from the '637 Appl'n).

FIG. 11 is an enlarged portion of FIG. 5 showing the first distal wall portion of the tube emphasized in gray.

FIG. 12 is a front view illustrating another refrigerator that can be used in conjunction with one or more embodiments shown and described herein.

FIG. 13 is a front view illustrating a state where a door of the refrigerator is opened.

FIG. 14 is a view schematically illustrating a disposition structure of a water supplying flow path of the refrigerator.

FIG. 15 is a perspective view illustrating the structure of a prior art water purifying apparatus.

FIG. 16 is a perspective view illustrating a structure of a prior art water purifying apparatus.

FIG. 17 is an exploded perspective view illustrating a state where a filter and a head of the prior art water purifying apparatus are separated.

FIG. 18 is an exploded view illustrating the structure of a prior art filter.

FIG. 18A is an illustration of a filter inserting portion according to one or more embodiments shown and described herein.

FIG. 19 is a longitudinal sectional view of FIG. 18.

FIG. 19A is a longitudinal sectional view of a filter structure according to one or more embodiments shown and described herein.

FIG. 19B is a longitudinal sectional view of another filter structure according to one or more embodiments shown and described herein.

FIG. 19C is a longitudinal sectional view of another filter structure according to one or more embodiments shown and described herein.

FIG. 19D is a longitudinal sectional view of another filter structure according to one or more embodiments shown and described herein.

FIG. 20 is a sectional view taken along line 9-9′ of FIG. 18.

FIG. 20A is a sectional view of a filter inserting portion according to one or more embodiments shown and described herein.

FIG. 20B is a sectional view of another filter inserting portion according to one or more embodiments shown and described herein.

FIG. 20C is a sectional view of a filter structure according to one or more embodiments shown and described herein.

FIG. 20D is a sectional view of yet another filter structure according to one or more embodiments shown and described herein.

FIG. 20E is a sectional view of another filter structure according to one or more embodiments shown and described herein.

FIG. 20F is a sectional view of another filter structure according to one or more embodiments shown and described herein.

FIG. 21 is a sectional view taken along line 10-10′ of FIG. 17.

FIG. 21A is a sectional view of a filter inserting portion according to one or more embodiments shown and described herein.

FIG. 21B is a sectional view of another filter inserting portion according to one or more embodiments shown and described herein.

FIG. 21C is a sectional view of another filter inserting portion according to one or more embodiments shown and described herein.

FIG. 21D is a sectional view of another filter inserting portion according to one or more embodiments shown and described herein.

FIG. 21E is a sectional view of another filter inserting portion according to one or more embodiments shown and described herein.

FIG. 21F is a partially cutaway perspective view illustrating an upper supporter of a filter according to one or more embodiments shown and described herein.

FIG. 22 is a partially cutaway perspective view illustrating an upper supporter of a prior art filter.

FIG. 22A is a top perspective view illustrating a connecting portion according to one or more embodiments shown and described herein.

FIG. 22B illustrates the connecting portion of FIG. 22A in greater detail.

FIG. 22C is a top view illustrating another connecting portion according to one or more embodiments shown and described herein.

FIG. 22D is a top view illustrating another connecting portion according to one or more embodiments shown and described herein.

FIG. 22E is a top perspective view illustrating another connecting portion according to one or more embodiments shown and described herein.

FIG. 22F is a top perspective view illustrating another connecting portion according to one or more embodiments shown and described herein.

FIG. 22G is a top view illustrating still another connecting portion according to one or more embodiments shown and described herein.

FIG. 22H is a top view illustrating another connecting portion according to one or more embodiments shown and described herein.

FIG. 22I is a top view illustrating another connecting portion according to one or more embodiments shown and described herein.

FIG. 22J is a top view illustrating still another connecting portion according to one or more embodiments shown and described herein.

FIG. 22K is a partial cutaway perspective view illustrating an upper supporter of a filter according to one or more embodiments shown and described herein.

FIG. 23A is a side view of an example filter structure according to one or more embodiments shown and described herein.

FIG. 23B is a perspective view of the housing cap of the filter structure of FIG. 23A according to one or more embodiments shown and described herein.

FIG. 23C is a perspective view of an example upper supporter according to one or more embodiments shown and described herein that can be positioned within the filter structure of FIG. 23A.

FIG. 23D is a cross-sectional view of the portion of the filter structure of FIG. 23A along a plane that passes between the bosses according to one or more embodiments shown and described herein.

FIG. 23E is an alternative view of the housing cap and the upper supporter of FIG. 23A according to one or more embodiments shown and described herein.

FIG. 23F is a cross-sectional view of the filter structure of FIG. 23A according to one or more embodiments shown and described herein.

FIG. 23G is another cross-sectional view of the filter structure of FIG. 23A taken along a plane that is perpendicular to the plane along which the view of FIG. 23F is taken according to one or more embodiments shown and described herein.

FIG. 23H is a view of a housing cap and upper supporter according to one or more embodiments shown and described herein.

FIG. 23I is a cross-sectional view of the housing cap and upper supporter of FIG. 23H according to one or more embodiments shown and described herein.

FIG. 23J is a cross-sectional view of another example housing cap and upper supporter according to one or more embodiments shown and described herein.

FIG. 23K is a cross-sectional view of another example housing cap and upper supporter according to one or more embodiments shown and described herein.

FIG. 23L is a side view of another example upper supporter according to one or more embodiments shown and described herein.

FIG. 23M is a perspective view of the upper supporter of FIG. 23L according to one or more embodiments shown and described herein.

FIG. 23N is a cross-sectional view of the upper supporter of FIG. 23L as part of a filter according to one or more embodiments shown and described herein.

FIG. 23P is a side view of a two-part housing of a filter structure according to one or more embodiments shown and described herein.

FIG. 23Q is a view of one of the parts of the two-part housing of FIG. 23P along the interface between the two parts according to one or more embodiments shown and described herein.

FIG. 24 is a side view illustrating a prior art head for use in conjunction with one or more embodiments shown and described herein.

FIG. 25 is an exploded perspective view illustrating a coupling structure of the head viewed from a side for use in conjunction with one or more embodiments shown and described herein.

FIG. 26 is an exploded perspective view illustrating the coupling structure of the head viewed from the other side for use in conjunction with one or more embodiments shown and described herein.

FIG. 27 is a cutaway exploded perspective view illustrating an internal structure of the head viewed from one side for use in conjunction with one or more embodiments shown and described herein.

FIG. 28 is a cutaway exploded perspective view illustrating the internal structure of the head viewed from the other side for use in conjunction with one or more embodiments shown and described herein.

FIG. 29 is a perspective view illustrating the head viewed from the lower side for use in conjunction with one or more embodiments shown and described herein.

FIG. 30 is a partially cutaway perspective view illustrating the head for use in conjunction with one or more embodiments shown and described herein.

FIG. 31 is a cutaway perspective view illustrating a state where a filter and the head are separated from each other.

FIG. 32 is an enlarged view of portion A of FIG. 31.

FIG. 33 is a view illustrating a shaft position in a state where the filter and the head are separated from each other.

FIG. 34 is a view illustrating a state where the filter is inserted into an inside of the head.

FIG. 35 is a view illustrating a state where the filter is fully inserted into the inside of the head;

FIG. 36 is a view illustrating a state where the filter is rotated for coupling in a state where the filter is fully inserted into the inside of the head.

FIG. 37 is an enlarged view of portion B in FIG. 36.

FIG. 38 is a view illustrating a shaft position in a state where the filter is coupled to the head.

### DETAILED DESCRIPTION

This Detailed Description describes exemplary embodiments of the invention and is not intended to limit the scope of the claims in any way. Indeed, the invention as claimed is broader than and unlimited by the preferred embodiments, and the terms used in the claims have their full ordinary meaning.

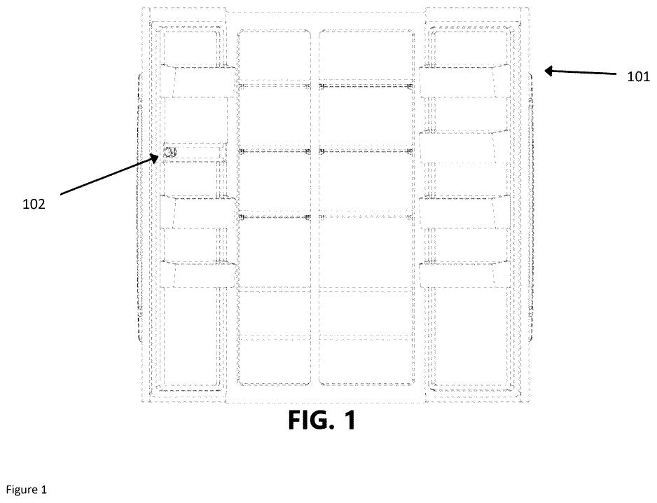

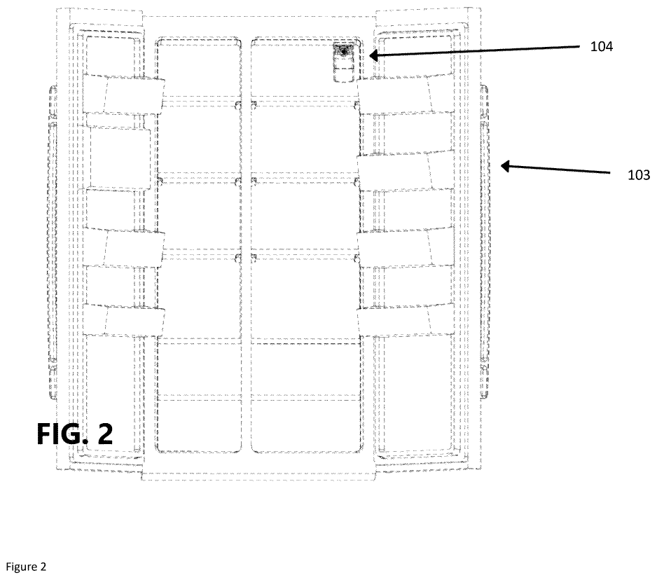

Referring now to FIG. 1, the illustration depicts a refrigerator 101 having a manifold 102 in its interior. Turning to FIG. 2, another depiction of a refrigerator 103 is presented. The refrigerator 103 houses a manifold 104.

Exemplary manifolds herein includes a channel or shaft, and a tube located within that channel or shaft. The tube has a distal end and a proximal end. The distal end of the tube includes a bridge that extends toward the inside of the tube from a distal wall portion of the tube. In exemplary embodiments, the bridge extends across the inside of the tube from one part of the distal wall to another part of the distal wall.

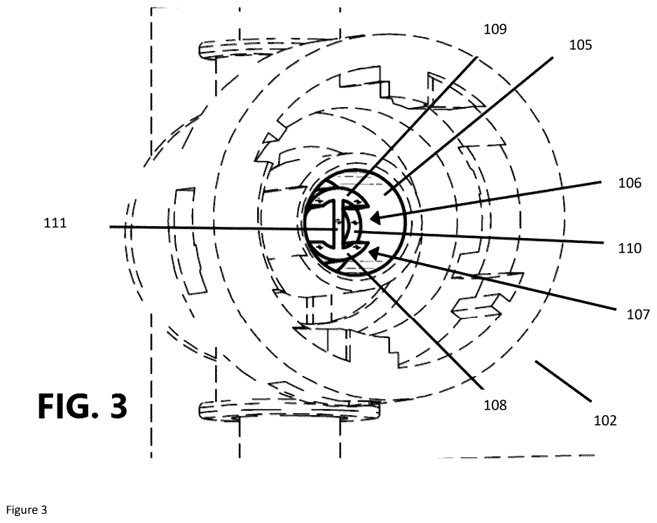

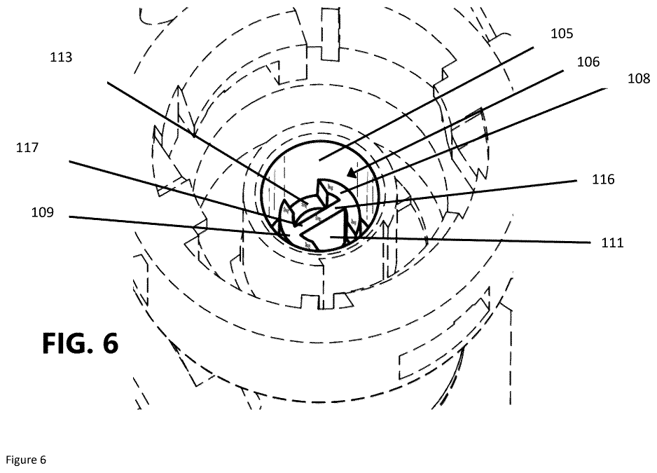

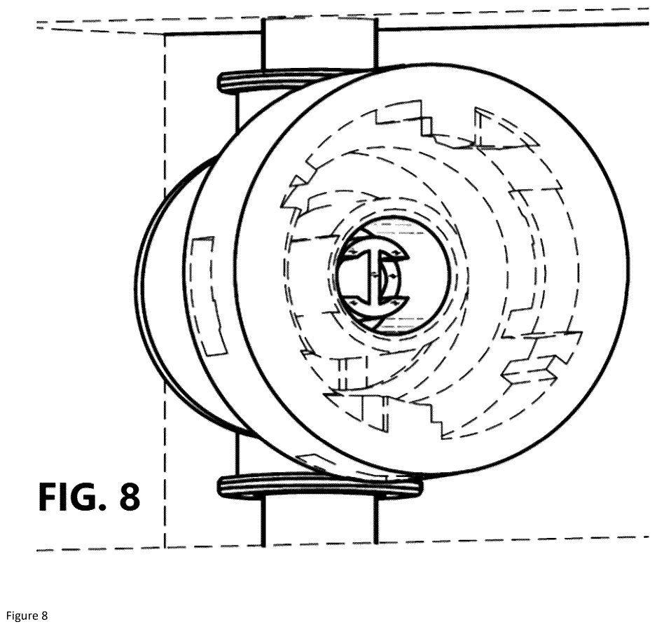

Referring now to FIGS. 3-10, these figures show various views of exemplary manifolds 102, 104, which will be referred to as simply manifold 102. It is understood that manifold 102 can be used in different refrigerators, e.g., refrigerator 101 and refrigerator 103.

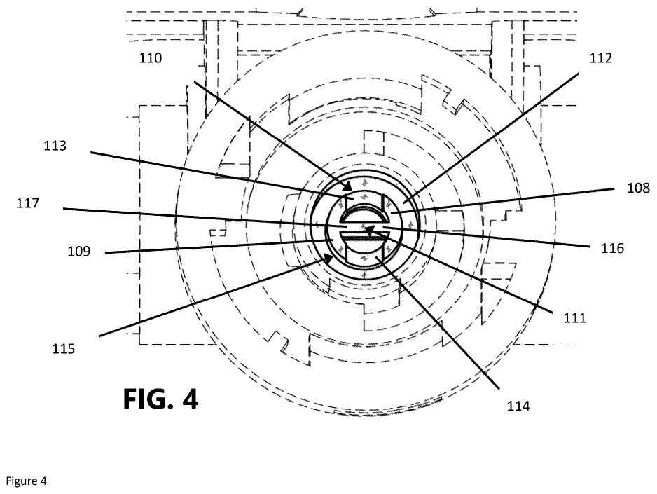

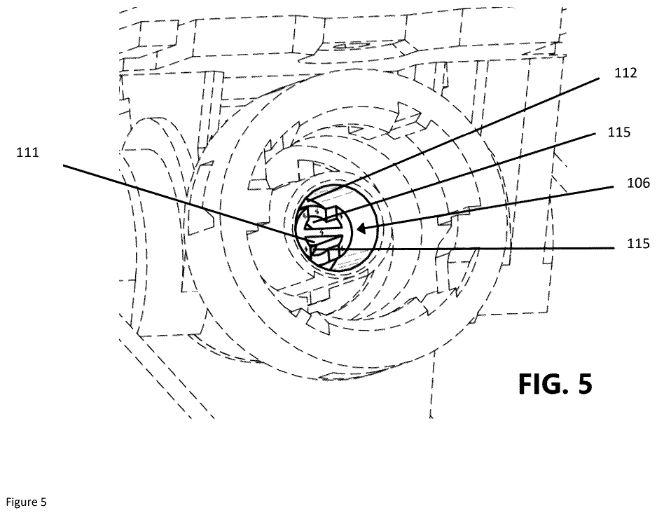

Exemplary manifold 102 includes a shaft 105, which has a tube 106 therein. Tube 106 has a distal end 107 and a proximal end 115 (FIG. 4 and FIG. 5). The distal end 107 of the tube 106 is farther from the proximal wall 112 (FIG. 4) and has at least a first distal wall portion 108 and a second distal wall portion 109 that are positioned farther away from the proximal end than another second wall portion, e.g., intermediate wall portion 110. In exemplary embodiments, the proximal end 115 of the tube 106 is at the proximal wall 112 (FIG. 4). A bridge 111 extends toward an inside of the tube 106 from the distal wall portions 108, 109. Another way to look at the bridge 111 in some exemplary embodiments is as a projection extending distally inside the tube 106 at a center of the tube 106.

In exemplary embodiments, a first distal wall portion 108 and a second distal wall portion 109 are separated by first intermediate wall portion 113 and second intermediate wall portion 114. FIG. 11 is an enlarged portion of FIG. 5 showing an exemplary first distal wall portion 108 of the tube 106 emphasized in gray. As can be seen, the exemplary first distal wall portion 108 of the tube 106 is a portion of tube 106 and not necessarily limited to the most distal surface of tube 106. In some exemplary embodiments, the first distal wall portion 108 is the portion of the tube 106 that extends past the first intermediate wall portion 113 and second intermediate wall portion 114, as shown in FIG. 11. Although not shown in a separate figure, like FIG. 11, the second distal wall portion 109 is similarly positioned, i.e., a portion of tube 106 and not necessarily limited to the most distal surface of tube 106. In some exemplary embodiments, the second distal wall portion 109 is the portion of the tube 106 that extends past the first intermediate wall portion 113 and second intermediate wall portion 114 opposite first distal wall portion 108.

Turning to FIG. 4, embodiments of the manifold 102 include a proximal wall 112 at the back or bottom of the shaft 105. In exemplary embodiments, bridge 111 can be considered to be a first bridge portion 116 extending toward an inside of the tube 106 from the first distal wall portion 108, across the inside of the tube 106, and toward the second distal wall portion 109. As shown in some of the figures, in exemplary embodiments, the bridge 111 extends down to the proximal wall 112.

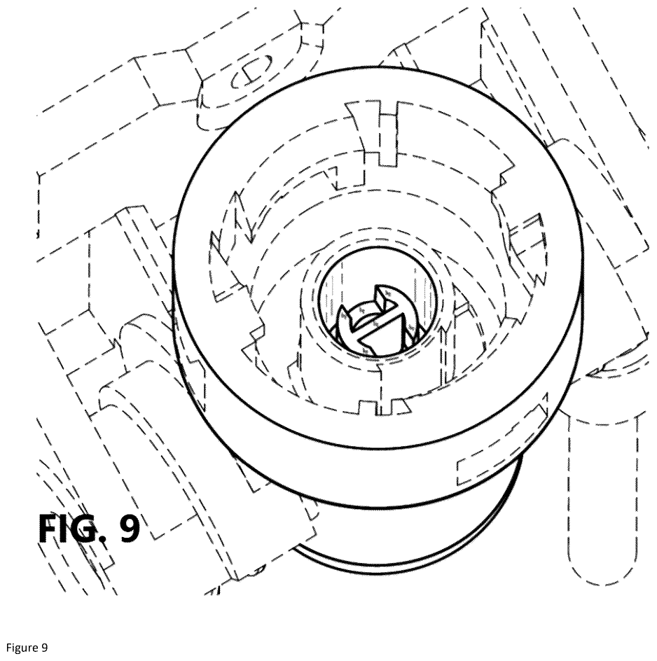

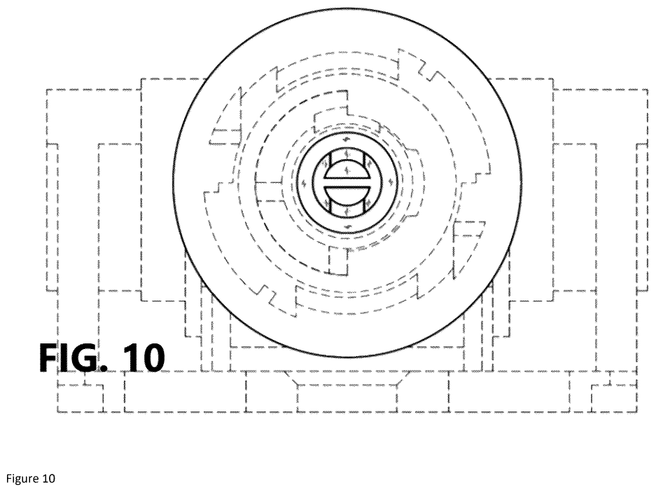

In some exemplary embodiments, bridge 111 can be considered to be a first bridge portion 116 extending toward an inside of the tube 106 from the first distal wall portion 108, across the inside of the tube 106, and toward the second distal wall portion 109 and a second bridge portion 117 extending toward an inside of the tube 106 from the second distal wall portion 109, across the inside of the tube 106, and toward the first distal wall portion 108. As shown in some of the figures (e.g., FIG. 4 and FIG. 10), in some exemplary embodiments, the bridge 111 extends down to the proximal wall 112 inside tube 106.

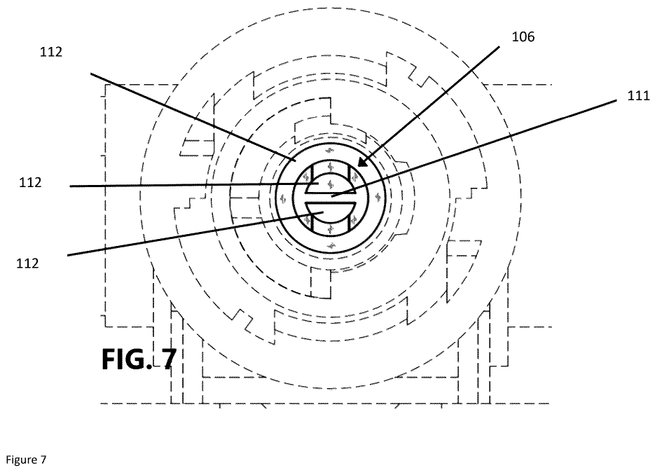

As shown in FIG. 7 and other figures, in exemplary embodiments, the bridge 111 is planar down to the proximal wall 112 inside tube 106.

In other exemplary embodiments, bridge 111 can be considered to be a projection that extends distally toward the distal end 107 of the tube 106, the projection being present at the midpoint of the distance between a point on the tube 106 and an opposite wall. In some of those exemplary embodiments, bridge 111 can be considered to be a projection that extends distally from the proximal wall 112 of the manifold toward the distal end 107 of the tube 106, the projection being present at the midpoint of the distance between a point on the tube 106 and an opposite wall.

In exemplary embodiments, bridge 111 can be considered to be a projection extending distally toward the distal end 107 of the tube 106, the projection being present at the midpoint of the distance between a point on a distal wall portion 108 of the tube 106 and an opposite wall 109. In some exemplary embodiments, bridge 111 as a distally extending projection can be considered to also extend laterally toward the point on the distal wall portion 108 of the tube 106. In some of those exemplary embodiments, bridge 111 as a distally extending projection can be considered to also extend laterally from the point on the distal wall portion 108 of the tube to another distal wall portion 109 of the tube. In exemplary embodiments, bridge 111 as a distally extending projection extends distally from the proximal wall 112 of the manifold toward the distal end 107 of the tube 106, the projection being present at the midpoint of the distance between a point on a distal wall portion 108 of the tube 106 and an opposite wall 109.

The above portion of the Detailed Description is from the '637 Appl'n and forms the basis for the claims as filed. The following portion of the Detailed Description is from the '820 Appl'n. Notably, a person skilled in the art will understand that, using this combined description, any of the teachings of the above can be applied to the material in the section below. Similarly, a person skilled in the art will understand that using this combined description, any of the teachings of the below section can be applied to the material in the section above. One skilled in the art using the teachings herein can easily adapt and interchange the elements described in the preceding and subsequent sections. The features, methods, and structures detailed herein can be readily applied in either direction, ensuring compatibility and functional integration across both embodiments.

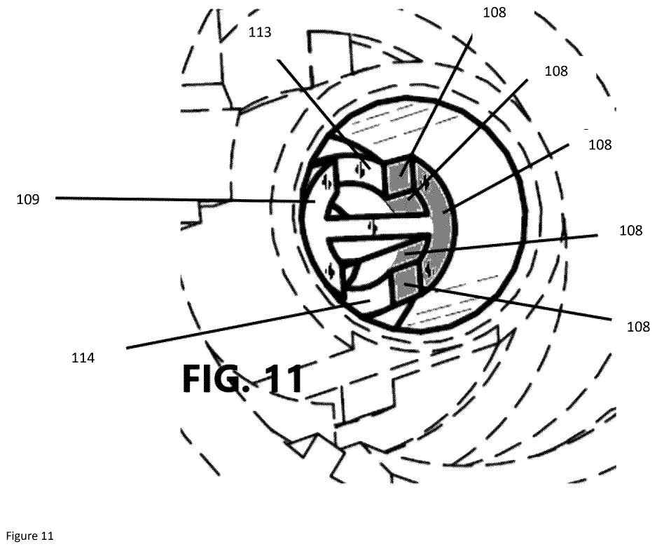

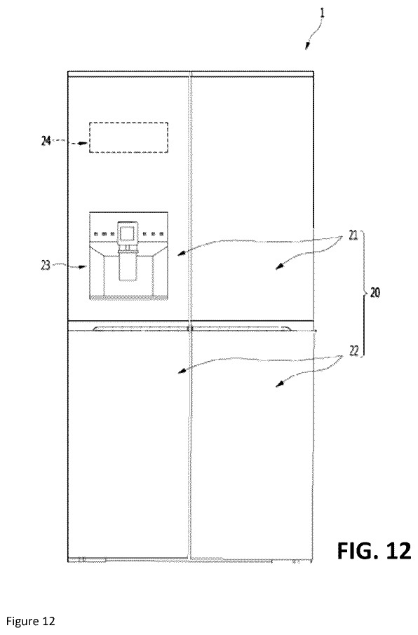

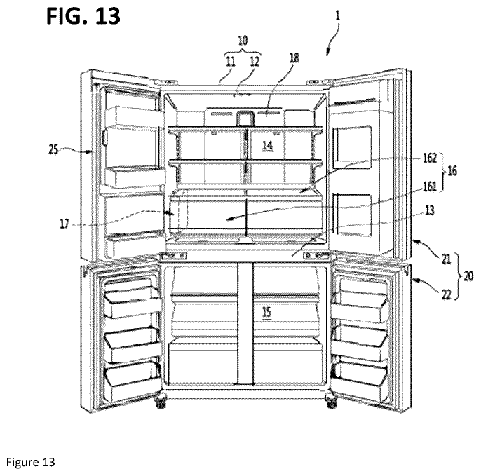

FIG. 12 is a front view illustrating another refrigerator that can be used with the filter structure according to an embodiment of the invention. FIG. 13 is a front view illustrating a state where a door of the refrigerator of FIG. 12 is opened.

With reference to FIGS. 12 and 13, an outer appearance of a refrigerator 1 ich includes a water purifying apparatus may be formed by a cabinet 10 that forms a storage space, and a door 10 that opens and closes the storage space of the cabinet 10.

The cabinet 10 may include an outer case 11 made of a metal material (not limited thereto) forming the outer surface and an inner case 12 made of a resin material (not limited thereto), which is coupled with the outer case 11 and forming a storage space in an inside portion of the refrigerator 1. Insulation material may be provided between the outer case 11 and the inner case 12 to insulate the space in the inside of the refrigerator 1.

The storage space may be separated in a vertical direction. The separation may be formed by a barrier 13. Accordingly, the storage space may include an upper refrigerating compartment 14 and a lower freezing compartment 15. The freezing compartment 15 may be further separated in a lateral direction. It will be apparent that the storage space may be divided into left and right compartments based on the barrier 13, and is not limited to any particular configuration.

The door 20 may include a refrigerating compartment door 21 and a freezing compartment door 22, which independently open and close the refrigerating compartment 14 and the freezing compartment 15, respectively.

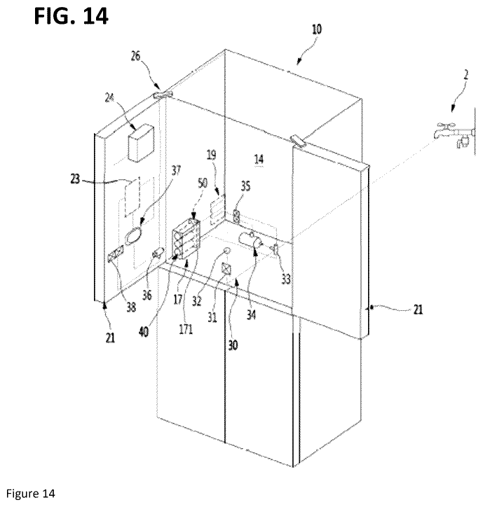

Both of the refrigerating compartment door 21 and the freezing compartment door 22 may open and close the refrigerating compartment 14 and the freezing compartment 15 by rotation thereof. For this, each of the refrigerating compartment door 21 and the freezing compartment door 22 may be rotatably connected to the cabinet 10 by a door hinge 26 (see FIG. 14). In addition, the refrigerating compartment door 21 may be configured as a French-type door configured such that a pair of doors independently rotate at both left and right sides.

A dispenser 23 and an ice maker 24 may be provided at one of the pair of refrigerating compartment doors 21.

The dispenser 23 may be provided at a front surface of the refrigerating compartment door 21, and enable a user to dispense water or ice by manipulating the dispenser 23 from the outside. An ice making compartment 25 may be provided above the dispenser 23.

The ice making compartment 25 is a heat insulating space in which ice is made and stored. The ice maker 24 may be accommodated in inside the ice making compartment. The ice making compartment 25 may be opened/closed by a separate door. Although not shown in the drawings, the ice making compartment 25 may communicate with the freezing compartment 15 by a cool air duct in a state in which the refrigerating compartment door 21 is closed, and may receive cool air necessary for the ice making from a freezing compartment evaporator (not shown).

A plurality of shelves and drawers for storing food may be provided inside the refrigerating compartment 14. For example, as shown in FIG. 13, a drawer assembly 16 may be provided at a bottom surface of the refrigerating compartment 14. The drawer assembly 16 may include a drawer 161 that is slidable and a cover 162 that shields a top surface of the drawer 161.

The drawer assembly 16 may be configured such that the inside thereof is visible therethrough, and a main water tank 34 (see FIG. 14) provided at a rear side of the refrigerating compartment 14 may be shielded by the drawer 161.

A water purifying apparatus 17 may be provided at a side of the drawer assembly 16 for water to be supplied and then supplying the purified water to the dispenser 23 and the ice maker 24. The water purifying apparatus 17 may be disposed between the accommodating space and the wall surface of the drawer 161 and may be shielded by a front surface of the drawer 161. Therefore, in a state where the drawer 161 is closed, the water purifying apparatus 17 is not exposed to the outside, and in a state where the drawer 161 is withdrawn, the water purifying apparatus is exposed to the outside thus providing access to the water purifying apparatus 17. It is understood that the mounting position of the water purifying apparatus 17 is not limited to one side of the drawer 161 and may be provided in the region of the refrigerating compartment 14 including the refrigerating compartment 14 or the refrigerating compartment door 21.

A plurality of shelves having a cantilever structure may be detachably provided above the drawer assembly 16 such that their heights are respectively adjustable. A main duct 18 may be provided at a rear surface of the refrigerating compartment 14 and cool air generated from an evaporator (not shown) may be supplied to the inside portion of the refrigerating compartment 14 through a plurality of discharging ports which are formed in a main duct 18.

FIG. 14 is a view schematically illustrating a disposition structure of a water supplying flow path of the refrigerator.

As shown in FIG. 14, the refrigerator 1 may include a water supplying flow path 30 that purities or cools water being supplied from an external water supply source and then dispenses water from the dispenser 23, or supplies the purified water to the dispenser 23 or the icemaker 24.

The water supplying flow path 30 may be directly connected to a water supply source 2, such as a water supply pipe, at the outside of the refrigerator, and be introduced into a space of the refrigerator through a tube guide 19 mounted in the cabinet 10 to be connected to an inlet portion of the water purifying apparatus 17 in the refrigerator.

The water supplying flow path 30 may include a water supply valve 31 and a flow rate sensor 32. The flow rate sensor 32 may be integrally formed with the water supply valve 31.

The water supplying flow path 30 may connect the water purifying apparatus 17 and a first branch pipe 33 with each other. The water supplying flow paths 30 branched from the first branch pipe 33 may be connected to the main water tank 34 and a first branch valve 35, respectively.

The water supplying flow path 30 which is connected to an outlet portion of the first branch valve 35 may extend along an upper surface after extending along a side wall of the inside of the cabinet 10 or a rear wall surface of the outside of the cabinet 10 through the tube guide 19 and may be introduced into the refrigerating compartment door 21 via the door hinge 26.

The water supplying flow path of the refrigerating compartment door 21 may be branched by a second branch pipe 36 and connected to an inlet portion of a sub water tank 37 and a second branch valve 38. The sub water tank 37 may be connected to the dispenser 23 so that cooled water is capable of dispensed through the dispenser 23.

An outlet portion of the second branch valve 38 may be respectively connected to the dispenser 23 and the ice maker 24 by the water supplying flow path 30 to be capable of supplying purified water to the dispenser 23 and the ice maker 24.

The water purified through the water purifying apparatus 17 may be cooled and then supplied to the dispenser 23 or may be supplied to the dispenser 23 or the ice maker 24 in a state in which the water is purified but not cooled.

The water purifying apparatus 17 may include a plurality of filters 40 for purifying supplied water and a head unit 50 to which the plurality of filters 40 are coupled and which is connected a flow path through which water flows. The water purifying apparatus 17 may include a case 171 that accommodates the filters 40 and the head unit 50.

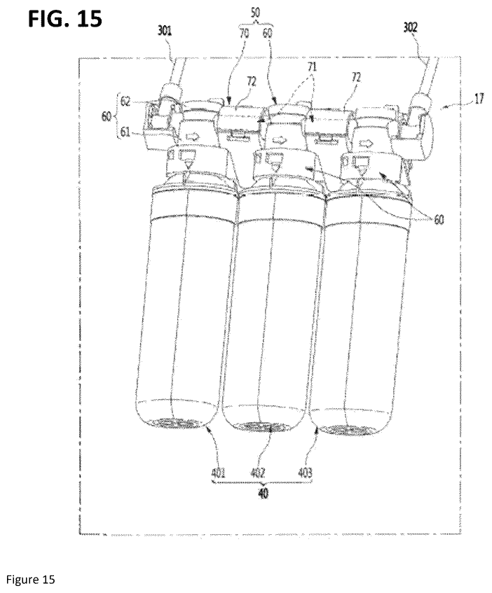

FIG. 15 is a perspective view illustrating the structure of a water purifying apparatus 17 that includes a plurality of filters 40 and a head unit 50.

The plurality of filters 40 may include a first filter 401 which is connected to a water inlet side of the head unit 50, a third filter 403 which is connected to a water outlet side of the head unit 50, and a second filter 402 disposed between the first filter 401 and the third filter 403 and thus is capable of purifying water. The first filter 401 may be a pre-carbon filter, the second filter 402 may be a membrane filter, and the third filter 403 may be a post-carbon filter.

It is understood that the plurality of filters is not limited to the number and types of the filters 40, and the number which is capable of being accommodated in the inside of the water purifying apparatus 17 and different types of functional filters from each other for effectively purifying water may be applied, including one or more filters according to the embodiments described herein.

The head unit 50 may include a plurality of heads 60 to which each of the filters 40 is coupled and a mounting member 70 on which the head 60 is rotatably seated.

A water inlet pipe 301 for supplying original water is capable of being connected to one end of the mounting member 70, and a water outlet pipe 302 for discharging purified water is capable of being connected to the other end thereof.

Each of the plurality of heads 60 may be independently rotated in a state where the plurality of heads 60 are mounted on the mounting member 70. The flow paths of the plurality of heads 60 are capable of being connected to each other by connecting pipes 71 and the original water which flows in through the water inlet pipe 301 is purified after passing through each of the filters 40 and then may be flows out from the water outlet pipe 302.

Each of the connecting pipes 71 may be mounted on the mounting member 70 and is provided between adjacent two heads 60 to each other to allow water to flow between each of the heads 60. A cover 72 may be mounted on one side of the mounting member 70 which corresponds to the connecting pipe 71 to shield the connecting pipe 71.

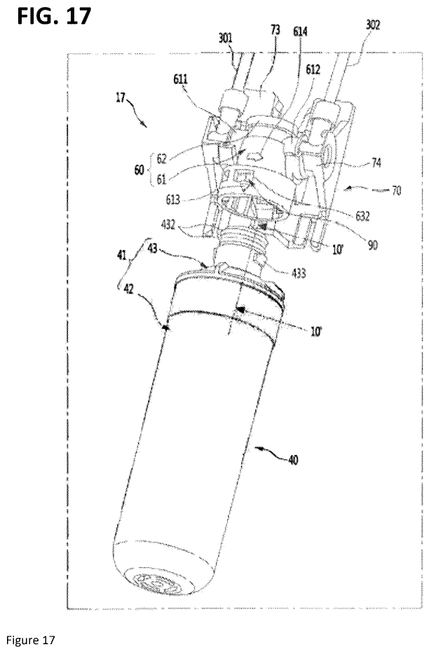

The head 60 may include a head body 61 to which an upper end of the filter 40 is inserted and then fixed, and a shaft (90 in FIG. 17) connected to the upper end of the filter 40 in the inside portion of the head body 61 and thus forms a flow path through which water flows. The head 50 may further include a head cap 62 for shielding an upper surface of the head body 61 into which the shaft 90 may be inserted.

The filter 40 may be fixedly mounted to the head 60 in a rotatable manner. The shaft 90 may be connected to the filter 40 to form a flow path in a process of the filter 40 being mounted and when the filter 40 is rotated, the shaft 90 is rotated along with the filter 40 so that the flow path of the shaft 90 is capable of being switched.

For example, in a case where the filter 40 is mounted, the flow path may be switched to the filter 40 side by the shaft 90 so that the water is capable of being purified through the filter 40. In a case where the filter 40 is separated, the supplying water is capable of being bypassed without passing through the filter 40, and thus the flow path is capable of being switched so that water passes through the head 60. The switching and detailed structure of the flow path will be described in more detail in the following other embodiments.

The case 171 may have various structures which can accommodate the filter 40 and the head unit 50. The case 171 is capable of fully accommodating the filter 40 and the head unit 50. Alternatively, the case 171 may accommodate a portion of the filter 40 and/or the head unit 50.

The case 171 may have a structure which is capable of being fixedly mounted at one side of the inside portion of the refrigerating compartment 14. Alternatively, the case 171 may not be provided and the mounting member 70 may be directly mounted to a side of the inner portion of the refrigerating compartment 14.

Only one filter 40 may be provided according to the function of the water purifying apparatus 17. In such case where only one filter 40 is provided, one head unit 50 and one mounting member 70 may be provided. The structure of the head 60 may have the same structure irrespective of whether there is just one head 60 or there are a plurality of heads 60. Hereinafter, a water purifying apparatus having one filter 40 and one head 60 will be described.

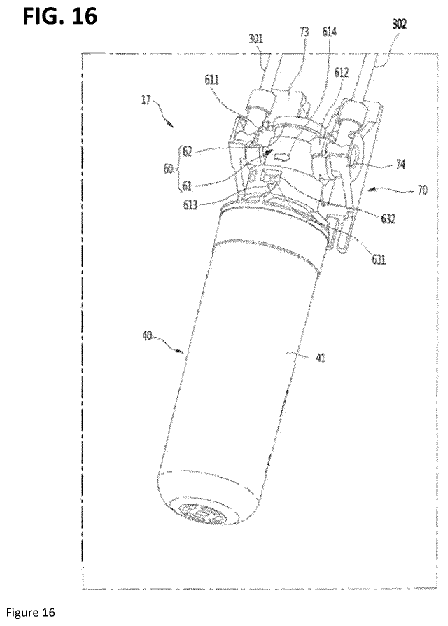

FIG. 16 is a perspective view illustrating a structure of another water purifying apparatus. FIG. 17 is an exploded perspective view illustrating a state where a filter 40 and a head 60 of the water purifying apparatus are separated. It should be appreciated that the filter in FIGS. 16 and 17 can be any one of the filters described herein. The water purifying apparatus 17 may further include a mounting member 70 on which the head 60 is mounted.

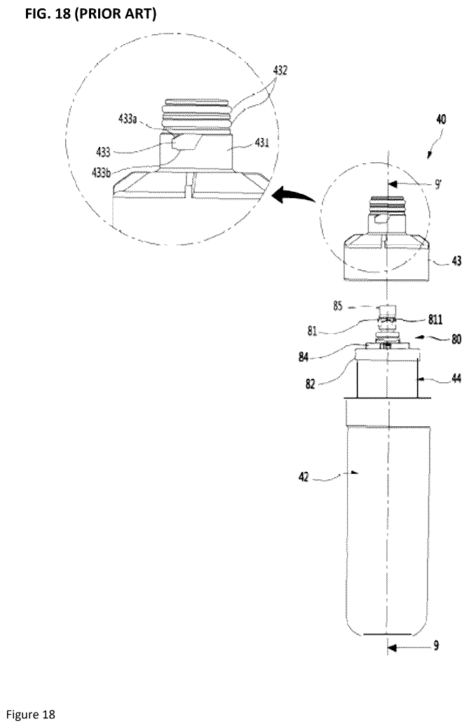

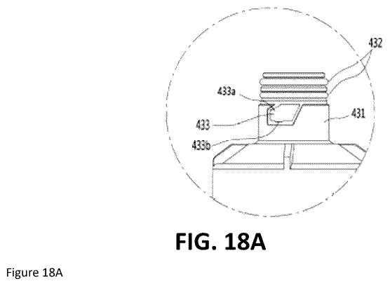

The filter 40 may have a cylindrical shape (not limited thereto). The outer shape of the filter 40 may be formed by the housing 41. The housing 41 may include a housing body 42 to accommodate a filtering member (44 in FIGS. 18 and 18A) in an inside portion thereof, and a housing cap 43 which may be coupled to an upper end of the housing body 42 to form an upper portion of the housing 41.

The housing body 42 may have a cylindrical shape (not limited thereto) to define a first accommodating space for accommodating the filtering member 44. The housing body 42 may have an upper opening portion.

The housing cap 43 may be coupled to the upper opening portion of the housing body 42. The housing cap 43 may define a second accommodating space for accommodating a portion of the filtering member 44. As such, a portion of the housing cap 42 may have a cylindrical shape. The housing cap 43 includes an upper opening portion. A portion of the shaft 90 is capable of being inserted through the upper opening portion of the housing cap 43 (discussed in more detail below).

The housing cap 43 may be inserted into an opened lower surface of the head 60. A pair of O-rings 432 may be provided at an upper end of the housing cap 43. The O-rings 432 may be hermetically sealed with the inner surface of the head 60 to prevent leakage.

A coupling projection 433 may be provided on an outer circumferential surface of the upper portion of the housing cap 43. The coupling projection 433 is capable of being moved along a coupling groove 631 which is formed on an inner surface of the head 60 when the upper portion of the filter 40 is inserted into the inside of the head 60.

The coupling projection 433 and the coupling groove 631 may be formed in a direction intersecting a direction into which the filter 40 is inserted. Accordingly, the filter 40 is rotated in a state of being inserted into the inside of the head 60 and may have a structure in which the coupling projection 433 and the coupling groove 631 are coupled to each other by rotation of the filter 40. In a state where the filter 40 and the head 60 are fully coupled to each other, the supplying water is capable of flowing into the inside portion of the filter 40 by the filter 40 and the flow path of the head 60 being connected to each other in the inside portion thereof.

The mounting member 70 may include a base 73 which is mounted to one side wall surface of the refrigerator 1 or the case 171, and rotating support portions 74 which project from both sides of the base 73 and rotatably support both sides of the head 60.

End portions of the water inlet pipe 301 and the water outlet pipe 302 may be disposed on the rotating support portion 74. The water inlet pipe 301 and the water outlet pipe 302 may be connected to a water inlet portion 611 and a water outlet portion 612 of the head 60 at the rotating support portion 74.

The head 60 may be rotatably mounted on the mounting member 70 by the rotating support portion 74. Therefore, a space for attachment and detachment of the filter 40 can be formed by operating rotation or tilting of the head 60 at the time of attachment and detachment of the filter 40. Thus, the manual operation for the attachment and detachment of the filter 40 can be more easily performed.

The head 60 may be formed in a cylindrical shape (not limited thereto) having an opened lower surface. The head 60 may include a head body 61 to which the filter 40 is inserted and fixed, and a shaft 90 which is accommodated in the inside of the head body 61. The head 60 may further include a head cap 62 to shield an opened upper surface of the head body 61.

An insertion indicating portion 613 tor indicating an insertion position of the coupling projection 433 may be formed on the outer surface of the head body 61. The insertion indicating portion 613 may be formed by printing, molding or machining. The user can recognize the position of the coupling groove 631 by viewing the insertion indicating portion 613, and may more easily perform alignment between the coupling projection 433 and the coupling groove 631.

A rotation indicating portion 614 for indicating the rotational direction of the filter 40 may be formed on the outer surface of the head body 61. The rotation indicating portion 614 may be formed by printing, molding or machining. The engagement projection 433 may be moved along and coupled to the inside of the coupling groove 631 by the user operating rotation of the filter 40 in a correct direction by the rotation indicating portion 514.

An opening portion 632 for checking the engaging restraint state of the coupling projection 433 may be further formed on the outer surface of the head body 61. The opening portion 632 may be formed at a position which corresponds to the position of the coupling groove 631 or may include at least a portion of the coupling groove 631.

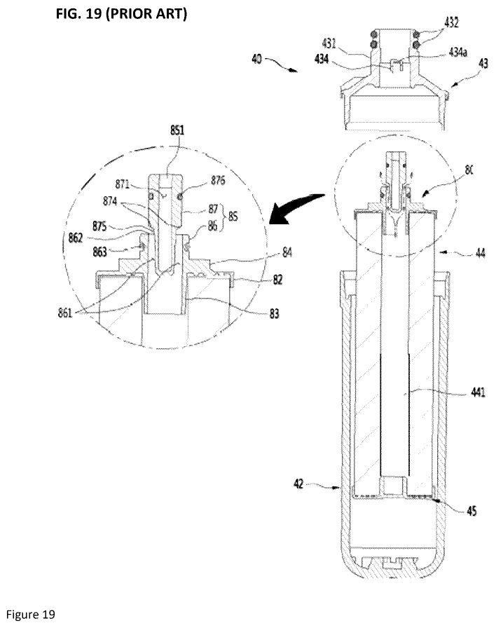

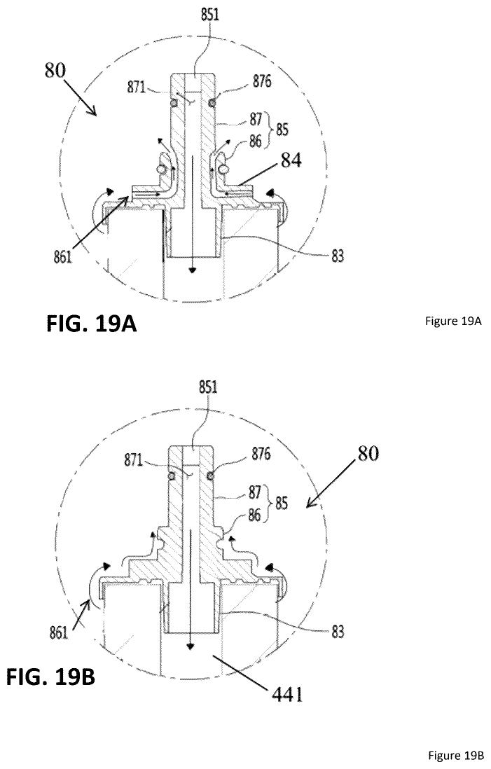

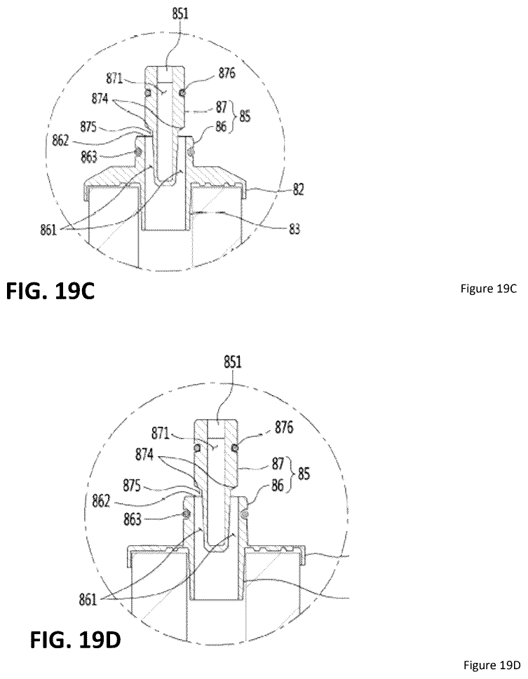

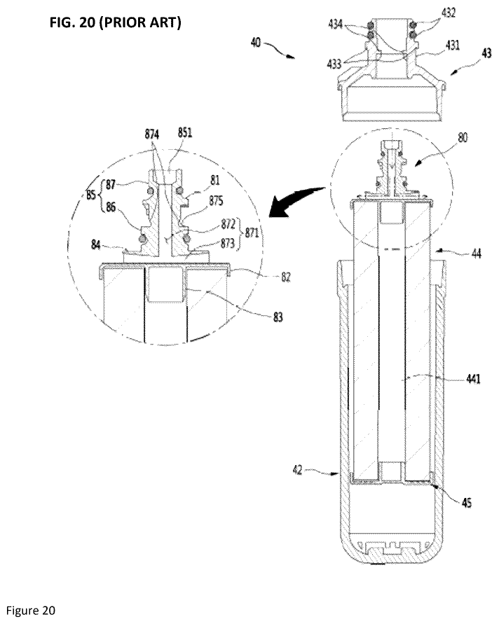

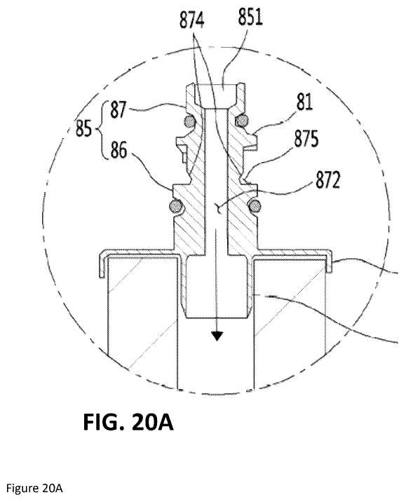

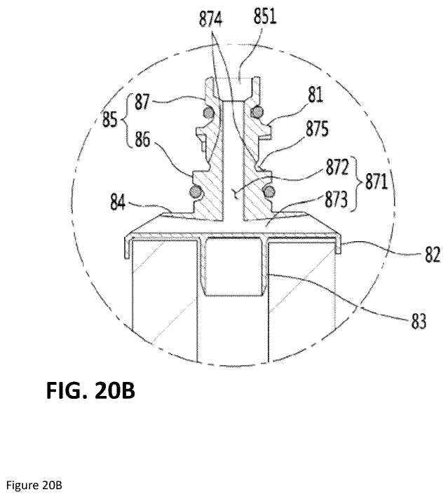

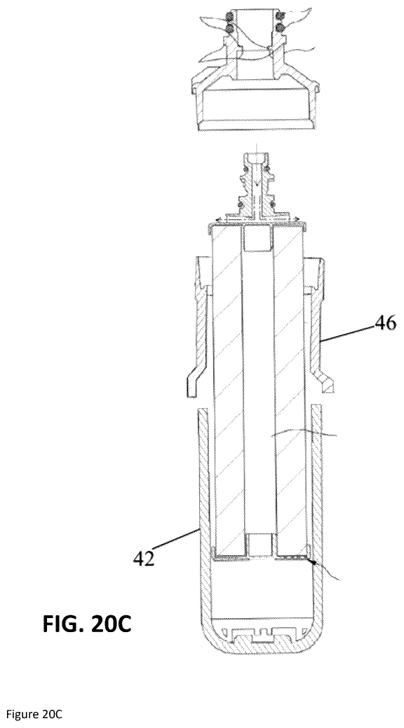

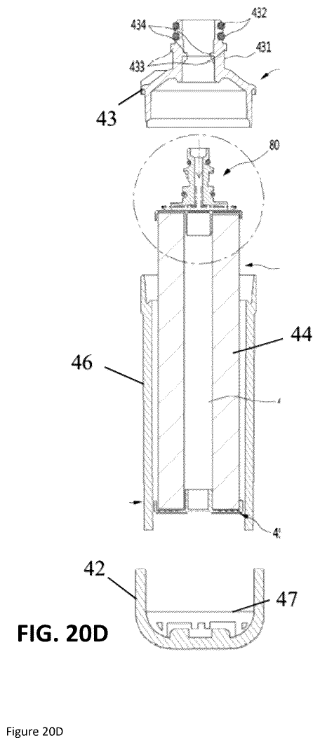

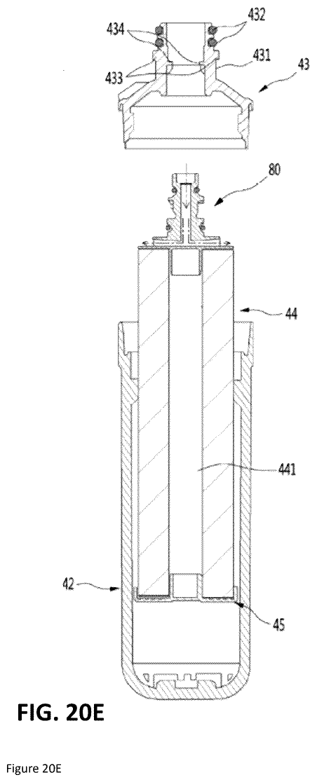

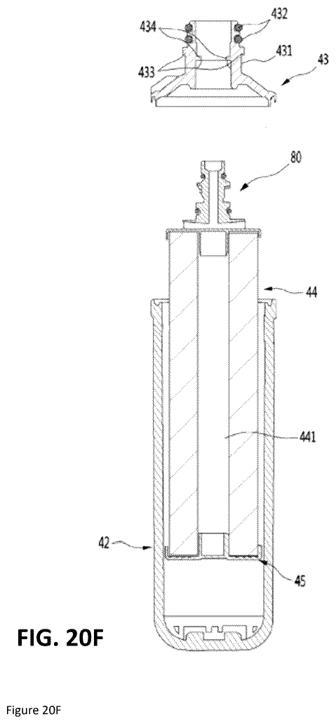

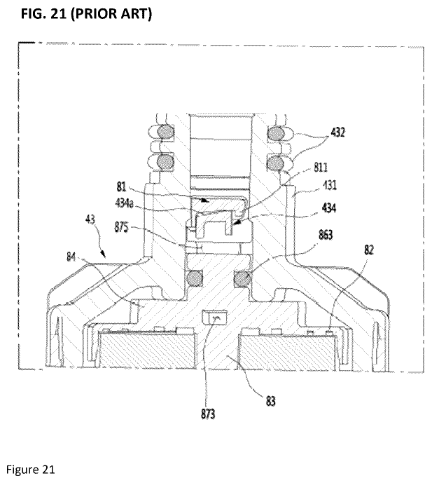

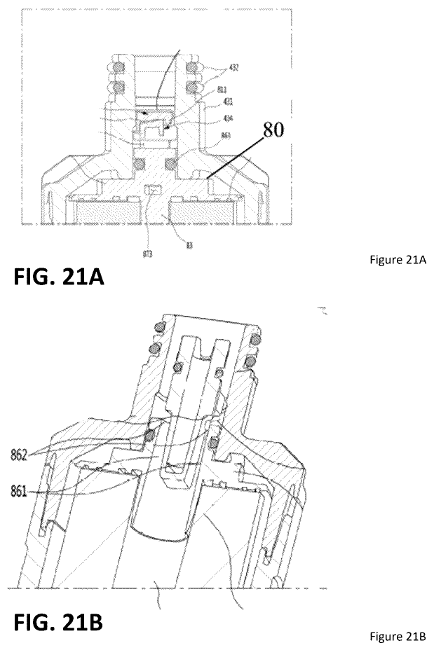

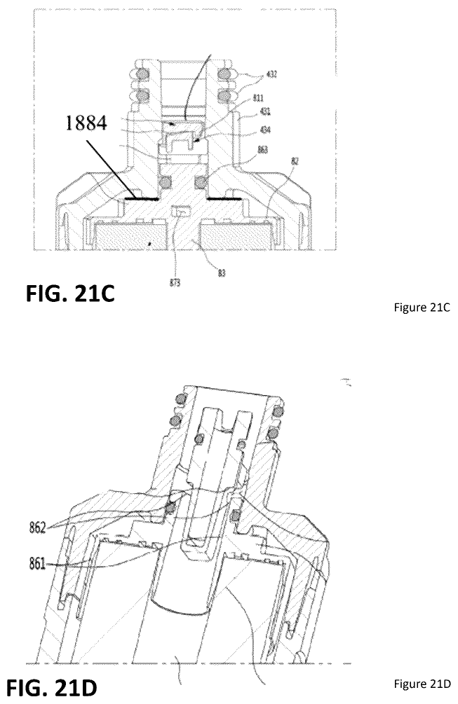

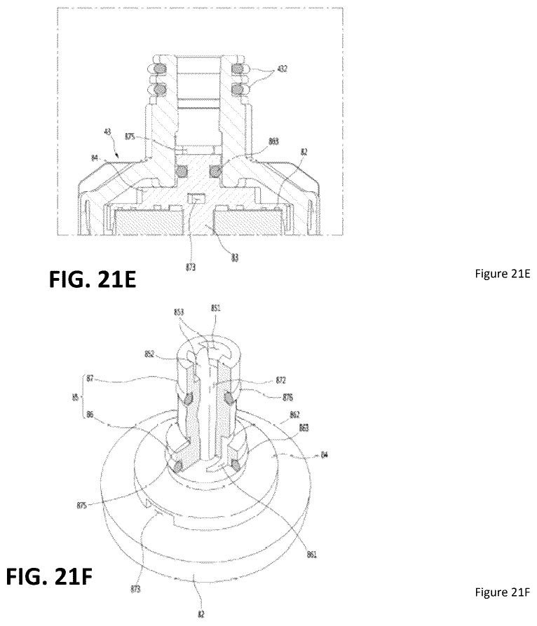

FIG. 18 is an exploded view illustrating the structure of a conventional filter. FIG. 18A illustrates the structure of a housing cap in accordance with one or more embodiments herein, which can replace the housing cap of the conventional filter illustrated in FIG. 18. FIG. 19 is a longitudinal sectional view of FIG. 18. FIG. 20 is a cross-sectional view taken along line 9-9′ of FIG. 18. FIG. 21 is a cross-sectional view taken along line 10-10′ of FIG. 17.

With reference to FIGS. 18-21, the filter 40 may include a filter housing 41 which forms an outer shape of the filter 40, a filtering member 44 provided in the filter housing 41, and an upper supporter 80 for supporting the filtering member 44.

The filter 40 may further include a lower supporter 45 for supporting the filtering member 44 in the filter housing 41.

The filter housing 41 may be formed in a cylindrical shape, and may be formed by the housing body 42 and the housing cap 43 being coupled together. A filter inserting portion 431 may be formed on the upper end of the housing cap 43. A plurality of O-rings 432 may be vertically arranged in the filter inserting portion 431.

In some embodiments, the filter housing further includes a connector 46 that is positioned between the housing body 42 and the housing cap 43, as shown in FIG. 20C. The opening of the housing body 42 is coupled to a first end of the connector 46, and the housing cap 43 is coupled to a second, opposing end of the connector 46. A length of the connector 46 extends between the first end and the second end of the connector. In various embodiments, the connector 46 has a substantially cylindrical shape and is configured to extend circumferentially around the filtering member 44. In the embodiment illustrated in FIG. 20C, the filtering member 44 can be positioned within the housing body 42, the connector 46, and the housing cap 43. Alternatively, as illustrated in FIG. 20D, a spacer 47 may be positioned within the housing body 42 to position the filtering member 44 within the connector 46. Accordingly, in such embodiments, the filtering member may be within the connector 46 and the housing cap 43, but is not positioned within the housing body 42. In still other embodiments, the housing cap 43 includes an accommodating space in which the upper supporter may be positioned, but does not include an accommodating portion for receiving the filtering member 44, as shown in FIG. 20F. Accordingly, the filtering member may be positioned within the housing body 42.

The coupling projection 433 may be formed on a lower side of the plurality of O-rings 432 on the outside of the filter inserting portion 431. A pair of coupling projections 433 may be formed at positions which are opposite to each other, and may be formed to have a size that is capable of being inserted into the coupling groove 631.

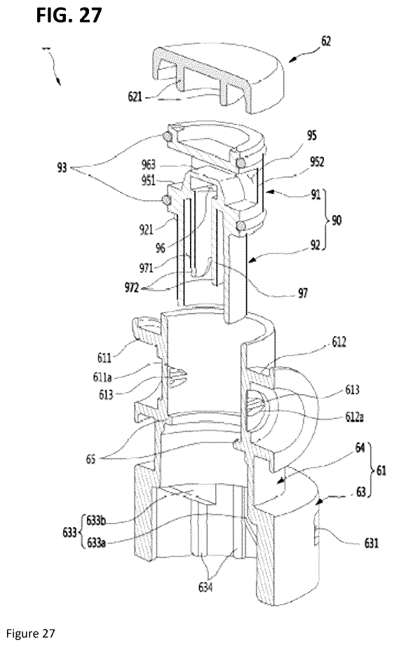

The coupling projection 433 may include a projection guide portion 433a. The projection guide portion 433a may be formed to have a slope or a predetermined curvature on the upper surface of the coupling projection 433. The coupling projection 433 is configured to be in contact with a groove guide portion (633 in FIG. 27) for guiding the coupling projection 433 to the entrance of the coupling groove 631 so as to guide rotation of the coupling projection 433 in one direction.

A restraining projection 433b which projects to a lower side may be formed on one side of the lower surface of the coupling projection 433. The restraining projection 433b may be engaged with the inside of the coupling groove 631 to be restrained. Accordingly, the filter 40 is capable of being fixed to the inside of the head 60 in a state where the coupling projection 433 is fully inserted into the inside of the coupling groove 631.

FIG. 18A illustrates the structure of a housing cap according to one or more embodiments described herein that can be incorporated into any of the filters shown and described herein. As with the conventional filter, a filter inserting portion 431 may be formed on the upper end of the housing cap 43. A plurality of O-rings 432 may be vertically arranged in the filter inserting portion 431.

In FIG. 18A, the coupling projection 433 may be formed on a lower side of the plurality of O-rings 432 on the outside of the filter inserting portion 431. A pair of coupling projections 433 may be formed at positions which are opposite to each other, and may be formed to have a size that is capable of being inserted into the coupling groove 631. In contrast to the conventional coupling projections, the pair of coupling projections 433 in FIG. 18A extend from a recess around the coupling projections rather than extending from the outer surface of the filter inserting portion 431.

The coupling projection 433 may include a projection guide portion 433a, as shown in FIG. 18A. The projection guide portion 433a may be formed to have a slope or a predetermined curvature on the upper surface of the coupling projection 433. The coupling projection 433 is configured to be in contact with a groove guide portion (633 in FIG. 27) for guiding the coupling projection 433 to the entrance of the coupling groove 631 so as to guide rotation of the coupling projection 433 in one direction.

A restraining projection 433b which projects to a lower side may be formed on one side of the lower surface of the coupling projection 433. The restraining projection 433b may be engaged with the inside of the coupling groove 631 to be restrained. Accordingly, the filter 40 is capable of being fixed to the inside of the head 60 in a state where the coupling projection 433 is fully inserted into the inside of the coupling groove 631.

In various embodiments, the inside portion of the filter inserting portion 431 may be formed having a hollow shape. A housing fastening portion 434 for being coupled with the upper supporter 80 may protrude from the inner side of the filter inserting portion 431. In other words, the upper supporter 80 is capable of being accommodated in the second accommodating space in which the housing cap 43 is defined. The upper supporter 80 may be coupled to the upper portion of the filtering member 44 and the inner surface of the housing cap 43, respectively.

As illustrated in FIGS. 21, 21A, and 21B, the upper surface 434a of the housing fastening portion 434 may be an inclined surface. For example, a pair of housing fastening portions 434 may be formed at positions facing each other, and may be formed so that inclined directions thereof are opposed to each other.

A supporter fastening portion 81 may be formed on the upper supporter 80 which corresponds to the housing coupling portion 434. For example, the supporter fastening portion 81 may be formed on the second extending portion 87. A hook portion 811 may be formed at one end of the supporter fastening portion 81.

In a case where the upper end of the upper supporter 80 may be rotated in one direction in a state of being inserted into the filter inserting portion 431, the hook portion 811 of the supporter fastening portion 81 moves along the inclined surface of the upper surface of the housing fastening portion 434 to be restrained. In a state where the upper supporter 80 is fully rotated, the hook portion 811 of the supporter fastening portion 81 engages with the end portion of the housing fastening portion 434 and thus the upper supporter 80 is capable of being coupled to the housing cap 43.

The supporter fastening portion 81 and the housing fastening portion 434 may have various structures which are mutually combined with each other and the filter housing 41 and the upper supporter 80 in the inside portion of the filter housing 41 may be integrated with each other by the supporter fastening portion 81 and the housing fastening portion 434 being coupled to each other. Therefore, when the filter 40 is rotated while the filter 40 is being mounted, the upper supporter 80 may also rotate with the filter 40.

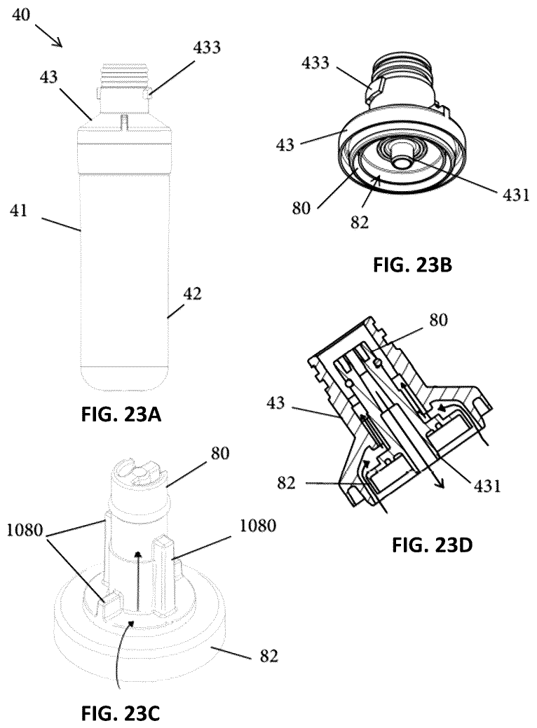

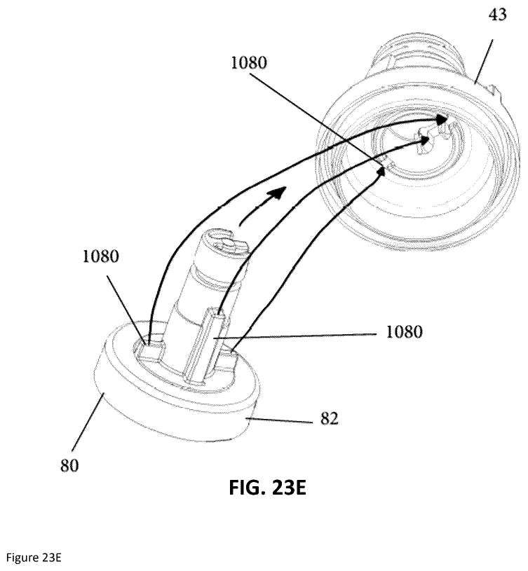

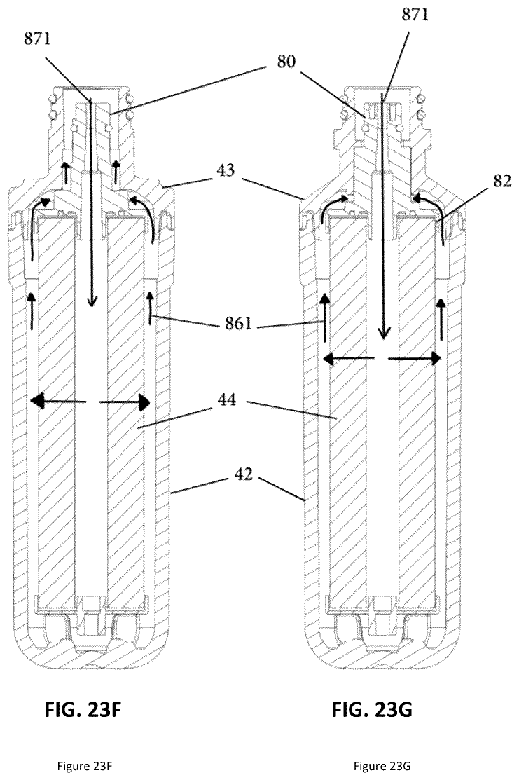

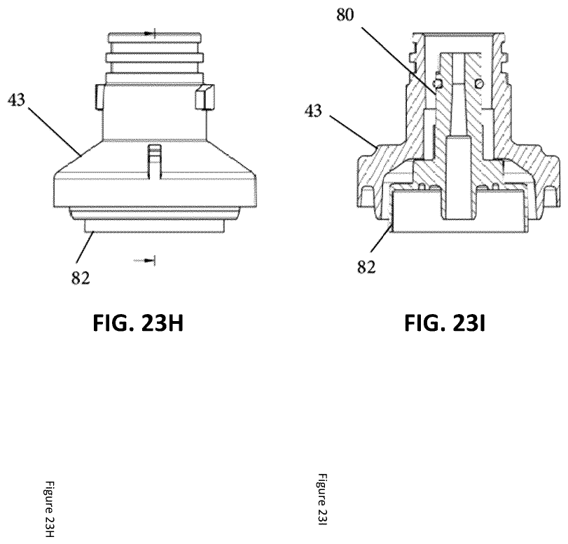

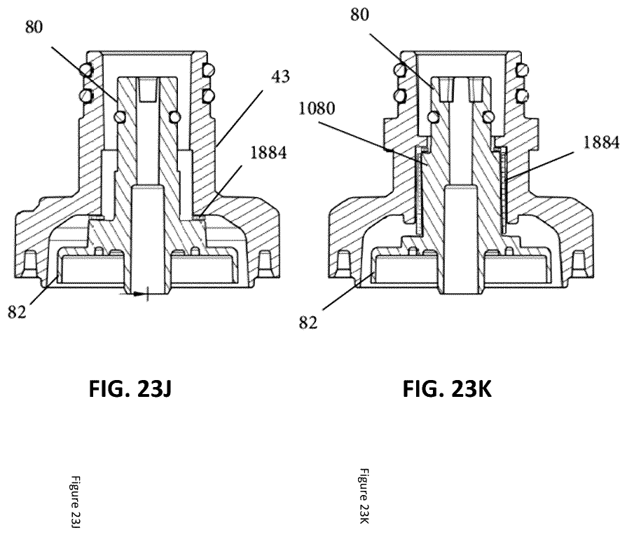

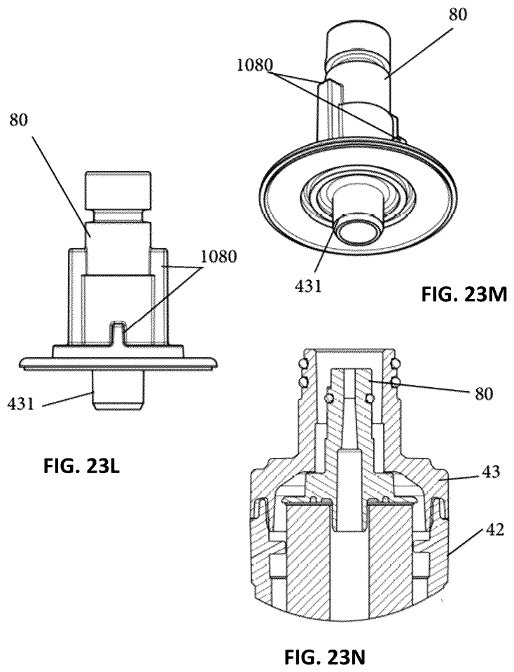

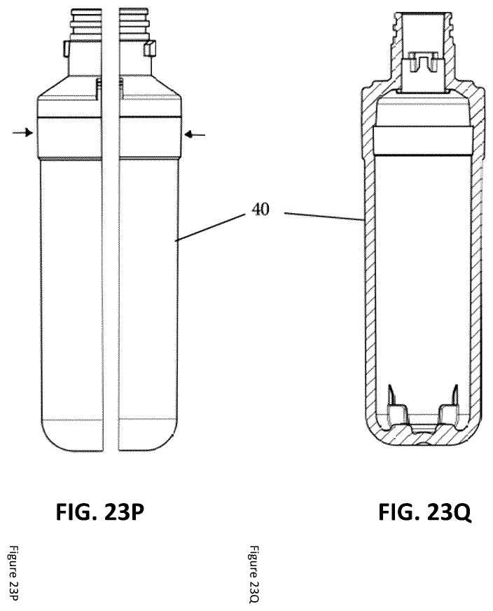

However, in some embodiments, a supporter fastening portion and a housing fastening portion may not be included, as in FIGS. 21E and 21F. As best shown in FIG. 23C, some such embodiments can include positioning features 1080 that ensure a proper orientation of the upper supporter 80 with respect to the filter housing 41 without fastening the upper supporter 80 and the filter housing 41 together. In such embodiments, the housing cap 43 and the upper supporter 80 may be fastened or secured together by ultrasonic welding, adhesives, or the like. The elimination of these fasteners may simplify manufacturing of the housing and upper supporters.

In various embodiments, the filtering member 44 may be accommodated inside the filter housing 41. The filtering member 44 may be a standard carbon filter or a membrane filter. However, it is understood that various types of filters may be used depending on the required purifying performance.

The filtering member 44 may be formed in a cylindrical shape (not limited thereto) having a hollow 441 formed at the center thereof in the vertical direction. The upper supporter 80 and the lower supporter 45 may be coupled to the upper end and the lower end of the filtering member 44 so that the filtering member 44 is capable of being fixedly mounted on the inside of the filter housing 41.

An outer diameter of the filtering member 44 may be smaller than the inner diameter of the filter housing 41 and a space for flowing water between the filter housing 41 and the outer surface of the filtering member 44 may be formed.

The upper supporter 80 may be disposed at the upper end of the filtering member 44 and extend in the upper direction to form a passage connecting the inlet portion of the filter inserting portion 431 and the hollow 441 to each other. Accordingly, water supplied from the head 60 is capable of flowing into the filtering member 44 through the filter inserting portion 431 and water purified in the filtering member 44 flows out to the head 60.

The upper supporter 80 may include a supporter accommodating portion 82 for accommodating the upper end of the filtering member 44, as shown in FIGS. 21, 21C, and 21D. However, in other embodiments, such as the embodiments illustrated in FIGS. 20E, 20G, 21A, and 21B, the upper supporter 80 does not include a supporter accommodating portion 82 that receives the upper end of the filtering member 44. Rather, the upper supporter 80 includes a disk portion.

The upper supporter 80 may further include a supporter inserting portion 83 which extends from a central portion of the supporter accommodating portion 82 in the lower direction and is inserted into the hollow 441 of the filtering member 44. In embodiments that do not include a supporter accommodating portion, such as those illustrated in FIGS. 21A and 21B, the supporter inserting portion 83 can extend from a central portion of the upper supporter 80. Accordingly, the supporter inserting portion 83 can be used to secure the position of the upper supporter 80 relative to the filtering member 44 despite the absence of a supporter accommodating portion.

In some embodiments, the supporter accommodating portion 82 is positioned within the housing cap 43, as illustrated in FIG. 21, while in other embodiments, the supporter accommodating portion may extend down past a lower edge of the housing cap and into the housing 42, as shown in FIG. 21D.

The upper supporter 80 may further include a supporter stepped portion 84 which projects from the upper surface of the supporter inserting portion 83 in the upper direction.

The upper supporter 80 may further include a supporter extending portion 85 extending from the center of the upper surface of the supporter stepped portion 84 toward the inside of the filter inserting portion 431.

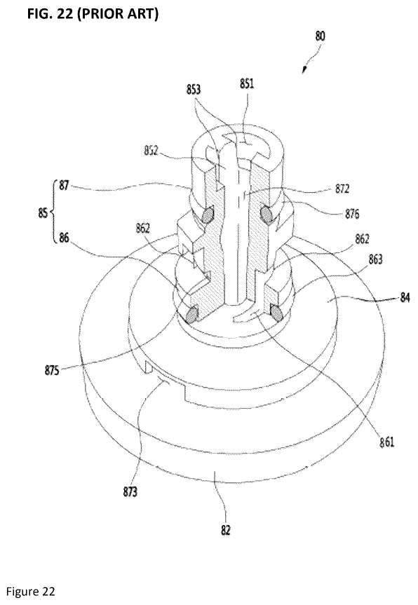

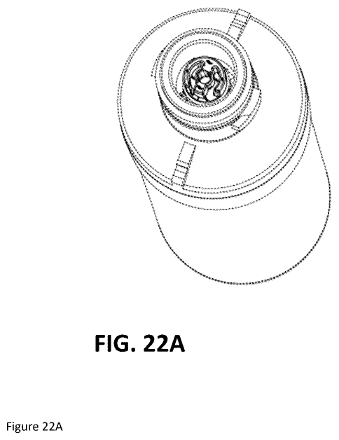

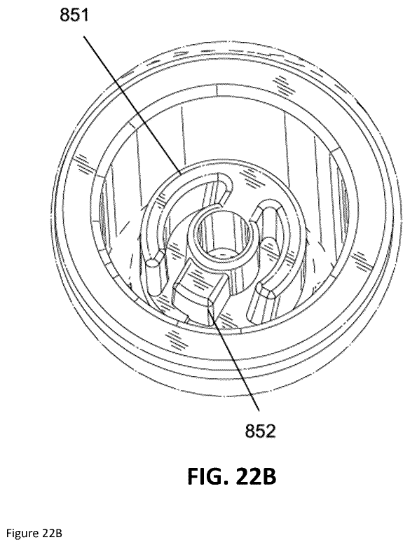

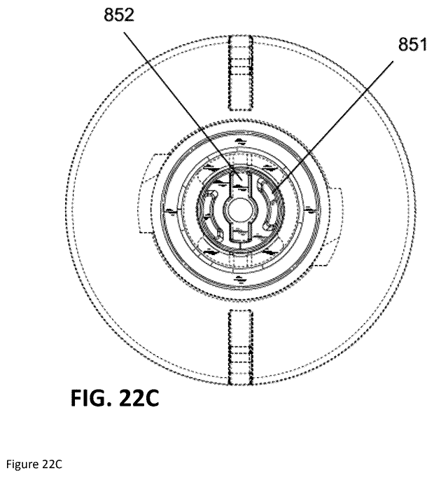

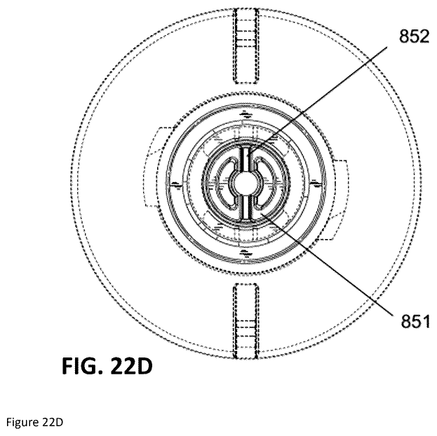

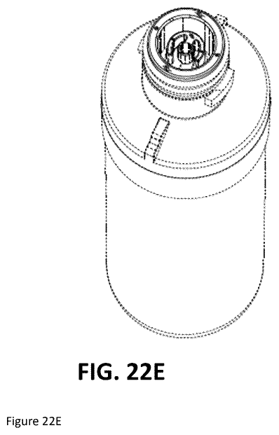

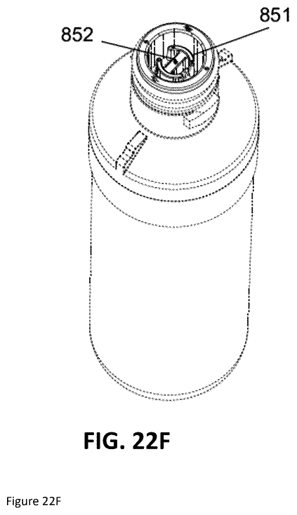

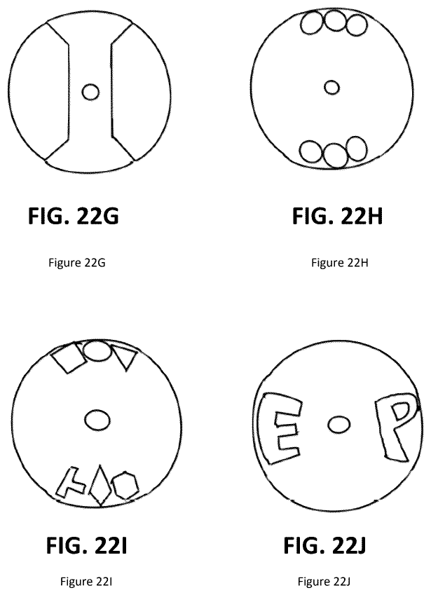

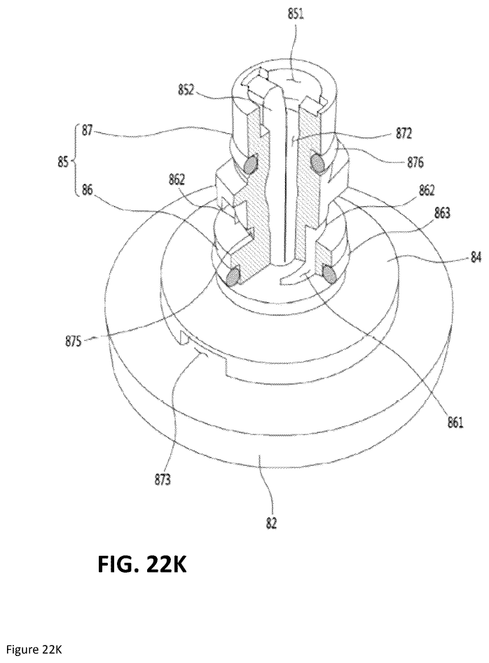

FIG. 22 is a partially cutaway perspective view illustrating an upper supporter of a conventional filter.

The upper supporter 80 will be described in more detail with reference to FIGS. 19-22. It should be appreciated that, although the upper supporter 80 illustrated in FIGS. 19-22 is a conventional upper supporter 80, one or more features shown in FIGS. 19-22 can be incorporated into the water filter or upper supporter of one or more embodiments described herein.

When the upper supporter 80 and the filtering member 44 are coupled together, the supporter accommodating portion 82 may surround the upper surface and a circumference of the filtering member 44. The supporter inserting portion 83 may be inserted into the hollow 441 such that it is in contact with an inner surface of the filtering member 44 so that the upper supporter 80 is capable of being fixedly mounted on the upper surface of the filtering member 44.

The inside portion of the supporter inserting portion 83 may be hollow such that it is capable of communicating with a filter outlet flow path 861 formed on the supporter extending portion 85. Accordingly, the purified water flowing into the hollow 441 of the filtering member 44 may pass through the supporter inserting portion 83, the filter outlet flow path 861 and a filter outlet port 862 of the end portion of the filter outlet flow path 861 in this order and be discharged through the opening of the filter inserting portion 431.

The supporter stepped portion 84 may protrude from the upper surface of the supporter accommodating portion 82. The supporter stepped portion 84 may have a smaller diameter than the supporter accommodating portion 82. The circumference of the supporter stepped portion 84 and the supporter accommodating portion 84 may be spaced apart from the inner surface of the housing cap 43 when the housing cap 43 and the upper supporter 80 are coupled together.

The supporter extending portion 85 may extend from the center of the supporter step portion 84 in the upper direction. The supporter extending portion 85 may be located in the filter inserting portion 431 when the housing cap 43 and the upper supporter 80 are coupled together. A filter inlet flow path 871 and a filter outlet flow path 861 may be formed in the inside of the supporter extending portion 85. Therefore, water supplied into the inside portion of the filter 40 and discharged from the purified water from the filter 40 is capable of being performed through the supporter extending portion 85.

For example, a first filter inlet flow path 872 extending in a lower direction may be formed on the opened upper surface of the supporter extending portion 85. The supporter stepped portion 84 may include a second filter inlet flow path 873 passing across the supporter stepped portion 84.

The second filter inlet flow path 873 may have an opening formed in a circumferential surface of the supporter stepped portion 84 and extending toward the center of the supporter stepped portion 84. The first filter inlet flow path 872 and the second filter inlet flow path 873 may be connected to each other at a lower end of the supporter extending portion 85, that is, at the inside of the supporter stepped portion 84.

Accordingly, the water which flows through the filter inserting portion 431 flows through the first filter inlet flow path 872 of the supporter extending portion 85 and then flows along the second filter inlet flow path 873 which is branched into both sides at the lower end of the first filter inlet flow path 872 to the outside and is thus capable of being discharged through an opening of the circumference of the supporter stepped portion 84.

The water which is discharged through the filter inlet flow path 871 flows along the space between the filter housing 41 and the filtering member 44. The water which flows into the outside of the filtering member 44 may be purified in the process of coming in the hollow 441 through the filtering member 44.

In contrast to the conventional filter illustrated in FIGS. 19, 20, 21, and 22, in various embodiments described herein, one or more features of the filter are modified to provide an alternative flow path for water through the filter, as shown in FIGS. 19A, 19B, and 20A. In some embodiments, when the upper supporter 80 and the filtering member 44 are coupled together, the supporter accommodating portion 82 may surround the upper surface and a circumference of the filtering member 44. The supporter inserting portion 83 may be inserted into the hollow 441 such that it is in contact with an inner surface of the filtering member 44 so that the upper supporter 80 is capable of being fixedly mounted on the upper surface of the filtering member 44.

The inside portion of the supporter inserting portion 83 may be hollow such that it is capable of communicating with a filter inlet flow path 871 formed through the supporter extending portion 85. Accordingly, the water to be purified flowing into the hollow 441 of the filtering member 44 from the supporter inserting portion 83, through the filter outlet flow path 861 and a filter outlet port 862 of the end portion of the filter outlet flow path 861 in this order and be discharged from the filter.

The supporter stepped portion 84 may protrude from the upper surface of the supporter accommodating portion 82. As shown in FIG. 19A, the filter outlet flow path 861 may pass through the supporter stepped portion 84 in some embodiments. The supporter stepped portion 84 may have a smaller diameter than the supporter accommodating portion 82. The circumference of the supporter stepped portion 84 and the supporter accommodating portion 82 may be spaced apart from the inner surface of the housing cap 43 when the housing cap 43 and the upper supporter 80 are coupled together. Accordingly, in some embodiments, the filter outlet flow path 861 may pass between the inner surface of the housing cap 43 and the supporter stepped portion 84, as illustrated in FIG. 19B.

The supporter extending portion 85 may extend from the center of the supporter step portion 84 in the upper direction. The supporter extending portion 85 may be located in the filter inserting portion 431 when the housing cap 43 and the upper supporter 80 are coupled together. A filter inlet flow path 871 and a filter outlet flow path 861 may be formed in the inside of the supporter extending portion 85, as shown in FIG. 19A. Therefore, water supplied into the inside portion of the filter 40 and discharged from the purified water from the filter 40 is capable of being passed through the supporter extending portion 85.

Alternatively, as shown in FIG. 19B, an outlet flow path 872 may be formed on the outer surface of the supporter extending portion 85 (e.g., between the supporter extending portion 85 and the housing cap 43). In such embodiments, the water flows in through the supporter extending portion 85 along the filter inlet flow path 871, in an outward direction through the filtering member 44, upward through the space between the filtering member 44 and the housing 42, and along the filter outlet flow path 861 across the supporter stepped portion 84 and between the supporter extending portion 85 and the housing cap 43 to the outside and is thus capable of being discharged through an opening between the supporter extending portion 85 and the housing cap 43. The water which flows into the hollow 441 of the filtering member 44 may be purified in the process of coming into the space between the filtering member 44 and the housing 42 through the filtering member 44. In such embodiments, one or more o-rings, seals, or gaskets may be eliminated as compared to the conventional filter shown and described in FIG. 19 (see FIG. 19B).

As illustrated in FIGS. 19, 19A, and 19B, the supporter extending portion 85 may include a first extending portion 86 which extends from the upper surface of the supporter stepped portion 84 and a second extending portion 87 which extends from the first extending portion 86 in the upper direction. In some embodiments, such as the embodiments illustrated in FIGS. 19C and 19D, the supporter stepped portion 84 can be eliminated and the supporter extending portion 85 may include a first extending portion 86 which extends from the supporter accommodating portion 82 and a second extending portion 87 which extends from the first extending portion 86 in the upper direction. In FIG. 19C, the upper surface of the supporter accommodating portion 82 is thicker as compared to various other embodiments, and the circumferential edge tapers from a side proximate the filtering member 44 to a side from which the first extending portion 86 extends. In FIG. 19D, the supporter stepped portion 84 can be completely removed. In some such embodiments, one or more parts of the housing cap can be extended, or a spacer can be inserted between the housing cap and the upper surface of the support accommodating portion 82 to support the housing cap.

Moreover, it should be appreciated that in some embodiments, the supporter stepped portion 84 and/or the upper surface of the supporter accommodating portion 82 may be in direct contact with an interior surface of the housing cap 43 (FIGS. 21, 21A, 21B, and 21D), while in other embodiments, a gasket or spacer 1884 can be positioned between the supporter stepped portion 84 and the housing cap 43, or between the supporter accommodating portion 82 and the housing cap 43. The gasket or spacer 1884 may be formed of a material that blocks the flow of water, or it may be formed from a porous material or include one or more flow paths to enable water to flow through the gasket or spacer 1884, depending on the particular embodiment.

The first extending portion 86 may have an outer diameter which is larger than the outer diameter of the second extending portion 87 and the filter outlet port 862 may be formed on the upper side portion of the first extending portion 86. It should be appreciated that in some embodiments (e.g., the embodiments illustrated in FIGS. 19A and 19B), the filter outlet port 862 can instead be a filter inlet port in accordance with the water flow path described hereinabove.

As shown in FIGS. 20, 20A, and 20B, a guide surface 874 which is recessed in the inside direction may be formed on the outer surface of the second extending portion 87 of the upper side of the supporter extending portion 85. The guide surface 874 may be inclined and spaced apart from the filter outlet port 862 (not shown in FIGS. 20-20B) in the upper direction. Therefore, when the purified water which is discharged to the filter outlet port 862 flows in the upper direction, the water is guided to the outside of the second extending portion 87 by the guide surface 874 so that the water can flow more effectively. Alternatively, when the water which enters the filter inlet flow path flows in the lower direction, the water is guided from the outside of the second extending portion 87 by the guide surface 874 so that the water can flow more effectively.

A portion of the second extending portion 87 may extend toward the inside of the first extending portion 86 at the lower end of the guide surface 874. In some embodiments, the filter outlet flow path 861 may be defined in a space between an inner surface of the first extending portion 86 and an outer surface of the second extending portion 87. The first filter inlet flow path 872 may extend from the opened upper surface of the second extending portion 87 to the lower end thereof. In some other embodiments, the filter inlet flow path 871 may be defined in a space between an inner surface of the first extending portion 86 and an outer surface of the second extending portion 87. The filter outlet flow path 861 may extend from the opened lower end of the second extending portion 87 to the upper surface thereof.

In embodiments, the outer diameter of the first extending portion 86 is formed to be somewhat smaller than the inner diameter of the filter inserting portion 431 and the purified water which is discharged through the filter outlet port 862 is capable of being discharged through a space between the first extending portion 56 and the filter inserting portion 431.

An outlet port groove 875, shown in FIGS. 20 and 20B, may be formed in the lower end of the guide surface 874 of the upper side of the filter outlet port 862. The outlet port groove 875 may be formed to be recessed along the circumference of the second extending portion 87. Accordingly, the water which is discharged from the filter outlet ports 862 is capable of flowing along the outlet port groove 875 and being discharged along the water outlet guide portion 965b formed on the outer surface of the shaft 90.

The outer diameter of the second extending portion 87 may correspond to the inner diameter of the shaft 90 which is located in the inside of the filter inserting portion 431. Therefore, in a case where the second extending portion 87 and the shaft 90 are communicably coupled together, water supplied through the inside of the shaft 90 is capable of flowing inside of the second extending portion 87.

A first extending portion O-ring 863 may be provided on the outside of the first extended portion 86 and a second extending portion O-ring 876 may be provided on the outside of the second extending portion 87. The first extending portion O-ring 863 is provided to create a hermetic seal between the inside of the filter inserting portion 431 and the first extending portion 86. The second extending portion O-ring 876 may be in close proximity with the inner surface of the shaft 90 to provide a hermetic seal between the second extending portion 87 and the shaft 90.

Therefore, the water which flows into the inside of the supporter extending portion 85 and the purified water which is discharged to the outside of the supporter extending portion 85 (or the water which flows along the outside of the supporter extended portion 85 and the purified water which is discharged through the inside of the supporter extending portion 85, depending on the particular embodiment) may flow through independent flow paths respectively without leakage or mixing with each other (or substantially reduced leakage/mixing).

Furthermore, in various embodiments, a first connecting portion 851 may be formed on the upper end of the supporter extending portion 85. The first connecting portion 851 may be recessed toward the inside from the upper end of the supporter extending portion 85 and may be symmetrical to both the left side and the right side thereof. The first connecting portion 851 may have a shape corresponding to that of the second connecting portion 972 of the shaft 90 (to be described below) so as to be engaged with each other when the second connecting portion 972 is inserted into the first connecting portion 851. The shaft 90 and the filter 40 may be rotated together in a state where the first connecting portion 851 and the second connecting portions 972 are coupled together.

The first connecting portion 851 may be symmetrical with respect to a projecting portion 852 projecting from a position which is opposite to the inner surface of the supporter extending portion 85 while being recessed at a predetermined depth. A first inclined surface 853 may be formed on both side ends of the first connecting portion 851, that is, on both side surfaces of the projecting portion 852. The first inclined surface 853 may be shaped such that the width of the first connecting portion 851 gradually increases and the width of the projecting portion 852 gradually decreases from the lower side to the upper side of the first inclined surface. In other words, the first connecting portion 851 may be formed so that the width thereof is gradually narrowed toward the depth direction to be recessed.

The first inclined surface 853 may be inclined in a direction crossing a lengthwise vertical direction of the first inclined surface 853, that is, in a direction of rotation of the filter 40. Accordingly, the projecting portion 852 may be formed so that the width thereof is gradually widen from the inner surface of the supporter extending portion 85 toward the center of the inner diameter of the supporter extending portion 85.

With such configuration, the first connecting portion 851 and the second connecting portion 972 can be more easily assembled. In addition, in a case where the torsion moment is applied when the first connecting portion 851 and the second connecting portion 972 are in contact with each other, the first connecting portion 851 and the second connecting portion 972 are slid so that the filter 40 can be more easily separated from the shaft 90.

It should be appreciated that the first connecting or engaging portion 851 may take any one of a variety of forms, as illustrated in FIGS. 22A-22K. For example, in some embodiments, the first connecting portion 851 is a projection that does not include a recess from the upper end of the supporter extending portion 85. The first connecting portion 851 may be asymmetrical to both the left side and the right side thereof, as shown in FIGS. 22A and 22B. The first connecting portion 851 may have a shape so as to be engaged with the second connecting portion 972 when the second connecting portion 972 is inserted into the first connecting portion 851. The shaft 90 and the filter 40 may be rotated together in a state where the first connecting portion 851 and the second connecting portions 972 are coupled together or alternatively only engage one another or only engage one another during a portion of the rotation of the filter.

The first connecting portion 851 may be asymmetrical with respect to a projecting portion 852, as illustrated in FIGS. 22A, 22B, and 22C. In still other embodiments, the projecting portion 852 does not extend from the first connecting portion 851, as illustrated in FIG. 22C. FIG. 22D illustrates yet another embodiment in which the projecting portion 852 extends between, but not from, the first connecting portion 851. FIG. 22E illustrates another embodiment similar to the embodiment illustrated in FIGS. 22A and 22B. However, in the embodiment of FIG. 22E, the projecting portion 852 has a different shape as compared to the projecting portion of FIGS. 22A and 22B. In FIG. 22F, the projecting portion 852 extends from the first connecting portion 851, but as in various other embodiments, the first connecting portion 851 does not include a recess and, instead, the first connecting portion 851 and the projecting portion 852 form a projection configured to contact the second connecting portion 972.

In some embodiments, the projecting surface does not include a recess, as illustrated in FIG. 22G. Alternatively, in embodiments, the projecting portion 852 can be the form of a plurality of pins (FIG. 22H), one or more different shapes (FIG. 22I), or one or more identifiers (FIG. 22J). It should further be appreciated that any one or more of the projecting portions 852 can be recessed from the top surface of the supporter extending portion 85, as shown in FIG. 22K in contrast to being formed on the end of the inner surface of the filter inlet flow path.

Accordingly, it should be appreciated that the connecting portion 851 of various embodiments can take any one of a variety of forms, provided it includes one or more surfaces configured to contact the second connecting portion 972.

Turning now to FIGS. 23A-23Q, another embodiment of an example filter is illustrated. As shown in FIG. 23A, the filter 40 includes a filter housing 41 which forms an outer shape of the filter 40. As in other embodiments shown and described herein, the filter housing 41 may be formed in a cylindrical shape and may be formed by a housing body 42 and a housing cap 43 coupled together. However, in alternative embodiments, the filter housing 41 may be formed by a first half and a second half, such as is shown in FIG. 23P.

As in previously described embodiments, the filter 40 includes one or more coupling projections 433, which may take any of the forms shown and described herein. In FIG. 23A, the coupling projections are formed at positions opposite to each other and are sized to be inserted into a coupling groove of a head coupled to a refrigerator.

As shown in FIG. 23B, an upper supporter 80 extends upward into the housing cap 43. In the embodiment depicted in FIG. 23B, the upper supporter 80 includes a filter inserting portion 431 configured to extend into a hollow of a filtering member, as described hereinabove. The upper supporter 80 is shown in greater detail in FIGS. 23C and 23E. In the embodiment illustrated in FIGS. 23C and 23E, the upper supporter 80 includes positioning features, such as the illustrated projections 1080, that ensure a proper orientation of the upper supporter 80 with respect to the filter housing 41 without fastening the upper supporter 80 and the filter housing 41 together.

As shown in FIGS. 23C, 23D, 23F, and 23G, in various embodiments, water is supplied to the filtering member through a water inlet flow path 871 along a central axis through the upper supporter 80 and the housing cap 40, into the hollow of the filtering member. The water is purified in the process of coming out of the hollow through the filtering member. The purified water then passes along a water outlet flow path 861 between the filtering member and the inner surface of the housing body 42, between the upper supporter and the inner surface of the housing cap 43, and out of the filter 40. FIGS. 23F and 23G are cross-sectional views of the same filter taken at planes that are perpendicular to one another in order to illustrate the water outlet flow path 861 with greater clarity.

As described above, it is contemplated that the filter 40 of FIGS. 23A-23G may include one or more of the alternatives described above, and in particular, alternative configurations of the upper supporter 80. For example, in the embodiments of FIGS. 23B-23G, the upper supporter includes a supporter accommodating portion 82 that is positioned within the housing cap 43, while in other embodiments, the supporter accommodating portion 82 may extend down past a lower edge of the housing cap 43, as shown in FIGS. 23H and 23I. As another example, one or more spacers 1884 can be positioned between the upper supporter 80 and the housing cap 43, as illustrated in FIGS. 23J and 23K. In embodiments, the spacer 1884 is positioned between positioning features 1080 and the housing cap 43 (FIGS. 23J and 23K), although one or more spacers can be positioned elsewhere between the upper supporter 80 and the housing cap 43. As above, the spacer 1884 may be formed of a material that blocks the flow of water, or it may be formed from a porous material or include one or more flow paths to enable water to flow through the gasket or spacer 1884, depending on the particular embodiment.

In still other embodiments, the upper supporter 80 does not include a supporter accommodating portion 82 that receives the upper end of the filtering member 44, as illustrated in FIGS. 23L-23N. Moreover, as described hereinabove, in some embodiments, the housing may be configured as two halves instead of a housing body and a housing cap, as is shown in FIGS. 23P and 23Q. Accordingly, the filter member and upper supporter may be partially positioned in a cavity defined by an inner surface of one half of the housing and the second half of the housing may be secured in place to enclose the filter member and upper supporter within the housing.

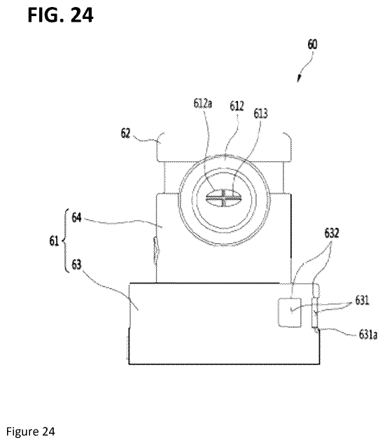

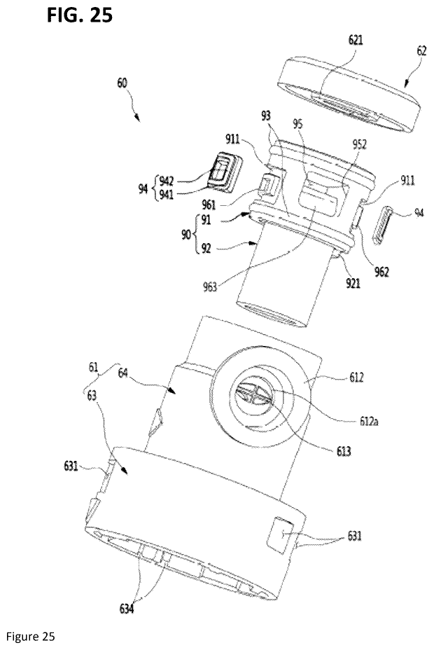

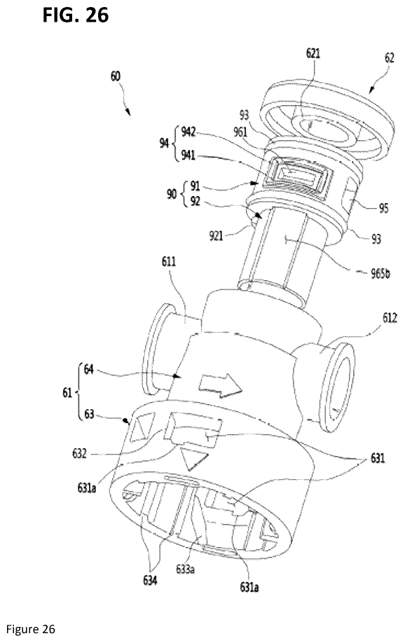

FIG. 24 is a side view illustrating an example head to which the filters of one or more embodiments described herein may be couplable. FIG. 25 is an exploded perspective view illustrating a coupling structure of the head viewed from a side, and FIG. 26 is an exploded perspective view illustrating the coupling structure of the head viewed from the other side.

With reference to FIGS. 24-26, the shaft 90 may be inserted through the opened upper surface of the head body 61, and the head cap 62 may shield or cover the opened upper surface of the head body 61.

The head body 61 may include a lower body 63 and an upper body 64.

The lower body 63 is a portion into which the filter inserting portion 431 may be inserted and to which the filter inserting portion 43 may be coupled. The lower surface of the lower body 63 may be opened so that the filter 40 can be accommodated. The coupling groove 631 for inserting the coupling projection 433 may be formed on the lower body 63.

An opening portion 632 for forming the coupling groove 631 may be formed on the lower body 63 and the insertion state of the coupling projection 433 may be confirmed through the opening portion 632. A plurality of supporting ribs 634 for supporting the outer side of the filter inserting portion 431 may be formed on the circumference of the inner surface of the lower body 63 to prevent the filter 40 from sagging in a state where the filter inserting portion 431 is inserted into the lower body 63.

The upper body 64 may be formed at an upper end of the lower body 63 and may have a smaller diameter than the diameter of the lower body 63. The shaft 90 may be mounted on the inside of the upper body 64 and the shaft 90 is inserted through the opened upper surface of the upper body 64 and thus may be mounted on the inside of the upper body 64.

The upper end of the filter inserting portion 431, the upper end of the supporter extending portion 85, and the lower end of the shaft 90 may be disposed on the inside of the upper body 64. A flow path through which purified water through the filter 40 is capable of flowing may be formed by coupling portions.

A water inlet portion 611 and a water outlet portion 512 may be formed to project to the outside in the upper body 64. The water inlet portion 611 and the water outlet portion 612 may communicate with a water inlet pipe 301 and a water outlet pipe 302, respectively. At this time, the water inlet portion 611 and the water outlet portion 612 can selectively communicate with the flow path formed in the shaft 90. The water inlet portion 611 and the water outlet portion 612 may be disposed in a straight line so as to face each other in the head.

The head cap 62 may shield the upper surface of the upper body 64. More particularly, the head cap 62 may press against the upper surface of the shaft 90 so that the shaft 90 can maintain a state of being fixedly mounted on the inside of the upper body 64. To this end, a cap support portion 521 extending to the upper surface of the shaft 90 may be formed on a lower surface of the head cap 62.

The shaft 90 is capable of selectively switching the flow path of water flowing in the inside of the head 60. The shaft 90 may be rotatably seated on the upper body 64. A filtering flow path 96 and a bypass flow path 95 may be formed in the shaft 90. The flow paths may be selectively connected to the water inlet portion 611 and the water outlet portion 612 by the rotation of the shaft 90.

The shaft 90 may include an upper part 91 and a lower part 92. The upper part 91 may have a larger diameter than the diameter of the lower part 92, and may have an outer diameter corresponding to the inner diameter of the upper body 64.

A shaft O-ring 93 may be provided at the upper end and the lower end of the upper part 91, respectively. The shaft O-ring 93 may provide a hermetic seal between the shaft 90 and the inner surface of the upper body 64 so as to prevent leakage of water flowing through the head 60.

A shaft inlet port 961 and a shaft outlet port 962 may be formed on the circumference of the upper part 91 between the plurality of shaft O-rings 93, respectively. More particularly, the shaft inlet port 961 and the shaft outlet port 962 may be formed at positions facing each other and at positions corresponding to the water inlet portion 611 and the water outlet portion 612. Therefore, water which passes through the water inlet portion 611 can flow in the shaft inlet port 961, and water which passes through the shaft outlet port 962 can be discharged through the water outlet portion 612.

On the other hand, the shaft inlet port 961 and the shaft outlet port 962 may have a rectangular shape; however it is not limited to this. A sealing member mounting portion 911 on which a sealing member 94 is mounted may be formed on the circumference of the shaft inlet port 961 and the shaft outlet port 962. The sealing member mounting portion 911 and the sealing member 94 may have a rectangular shape corresponding to the shaft inlet port 961 and the shaft outlet port 962.

At this time, the sealing member 94 may include a pressing portion 941 which is pressed into and mounted on the inside of the sealing member mounting portion 911, and a sealing portion 942 which projects along the circumference of the pressing portion 941. The sealing portion 942 may be in contact with the inner surface of the upper body 64 when the shaft 90 is mounted. Accordingly, when the shaft inlet port 961 and the shaft outlet port 962 are connected to the water inlet portion 611 and the water outlet portion 612 by the rotation of the shaft 90, leakage of water between the shaft 90 and the head 60 is prevented or substantially reduced. The shape of the sealing member 94 may be formed to be lengthened in a direction in which the shaft 90 is rotated so that the removal of the sealing member 94 from the shaft 90 or interference of the sealing member 94 with the shaft 90 is minimized during the rotation of the shaft 90.

A sealing rib 613 may be formed in a water inlet port 611a and a water outlet port 612a which are formed in the water inlet portion 611 and the water outlet portion 612, respectively. The sealing ribs 613 prevent the sealing member 94 from being separated or damaged and may be formed to cross the water inlet port 611a and the water outlet port 612a of the inner surface of the upper body 64. The sealing ribs 613 may extend laterally and a plurality of sealing ribs 613 may be disposed in a direction intersecting each other.

Therefore, the sealing member 94 which is passed by the water inlet port 611a and the water outlet port 612a, which are formed in the water inlet portion 611 and the water outlet portion 612 respectively, is hooked into the water inlet port 611a and the water outlet port 612a in a process of the rotation of the shaft 90. Thus, the sealing member 94 is capable of being prevented from being separated from the sealing member mounting portion 911. In other words, since a state where the sealing ribs 613 press against the outer surface of the sealing member 94 in the process of the rotation of the shaft 90, the sealing member 94 is capable of being prevented from being separated from the sealing member mounting portion 911.

A bypass inlet port 951 and a bypass outlet port 952 may be formed between the shaft inlet port 961 and the shaft outlet port 962 of the outer surface of the upper part 91, respectively. The bypass inlet port 951 and the bypass outlet port 952 may also be disposed at positions facing each other. Accordingly, in a case where the bypass inlet port 951 and the bypass outlet port 952 are aligned with the water inlet portion 611 and the water outlet portion 6·12 by the rotation of the shaft 90, the water supplied to the water inlet portion 611 is capable of being discharged directly to the water outlet portion 612 through the bypass flow path 95.

The bypass inlet port 951 and the bypass outlet port 952 may be formed at positions which are the same height as the shaft inlet port 961 and the shaft outlet port 962, respectively, and which are rotated by 90 degrees to each other. Therefore, to connect the filtering flow path 96 or the bypass flow path 95 to the water inlet portion 611 and the water outlet portion 612, the shaft 90 should be rotated by 90 degrees.

A portion which forms the upper end of the filtering flow path 96 is capable of projecting from the bypass flow path 95 in the inside of the upper part 91. Accordingly, it is possible to realize the filtration flow path 96 and the bypass flow path 95 at the same time in a state where the height of the shaft 90 is minimized. Through this, the head 60 and the water purifying apparatus 17 can have a more compact configuration.

A rotating projection 921 may be provided on the lower surface of the upper part 91. A pair of rotating projections may be formed and one rotating projection may be formed at a position corresponding to the shaft inlet port 961 and the shaft outlet port 962, respectively. In other words, the pair of rotating projections 921 may be formed at positions which are rotated by 90 degrees with respect to each other.

On the other hand, the lower part 92 may extend from the center of the upper part 91 in the lower direction. The lower part 92 may be smaller than the inner diameter of the seating portion 65 and extend through the seating portion 65 in the lower direction. The lower part 92 may extend to a length such that the shaft 90 and the upper supporter 80 can be engaged with each other when the filter 40 is coupled to the head 60.

A water outlet guide portion 965b may be formed on one side surface of the lower part 92. The water outlet guide portion 965b may extend vertically from the lower side of the shaft outlet port 962. For example, the water outlet guide portion 965b may be formed by cutting a portion of the outer surface of the lower part 92 having a cylindrical shape into a planar shape.

Therefore, in a state where the shaft 90 is mounted on the head 60, the water outlet guide portion 965b of the shaft 90 may be spaced apart from the inner surface of the head 60 and thus the shaft water outflow path 965 which is a flow path of water is formed. Since the lower end of the water outlet guide portion 965b is located on the upper side of the filter outlet port 862, the water discharged from the filter outlet port 862 is moved along the water outlet guide portion 965b in the upper direction, and then passes by the shaft outlet port 962 and the water outlet portion 612 in this order and flows to the water outlet pipe 302.

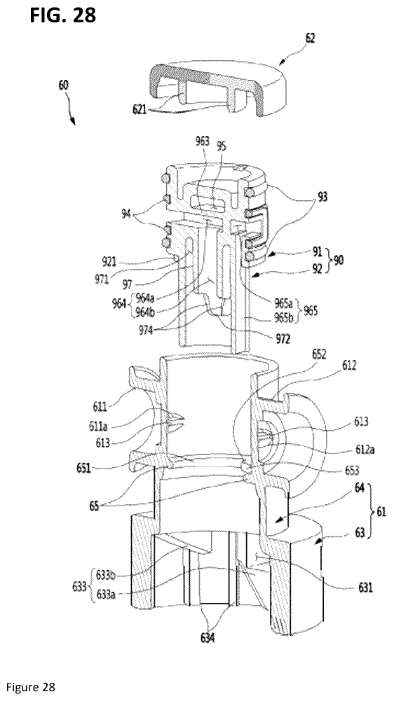

FIG. 27 is a cutaway exploded perspective view illustrating an internal structure of the head viewed from one side. FIG. 28 is a cutaway exploded perspective view illustrating the internal structure of the head viewed from the other side.

FIG. 27 illustrates a longitudinal section in a state where the bypass flow path 95 is switched to be connected to the water inlet portion 611 and the water outlet portion 612. As shown, a bypass flow path 95 passing through the center of the upper part 91 may be formed on the upper part 91, and the bypass inlet port 951 and the bypass outlet port 952 may be formed on both sides of the circumference of the upper part 91, respectively.

The bypass inlet port 951 and the bypass outlet port 952 may be larger than the sizes of the water inlet port 611a and the water outlet port 612a, and may be positioned between a pair of shaft O-rings which are vertically disposed. Therefore, the water passing through the bypass flow path 95 in a state where the bypass flow path 95 is aligned with the water inlet portion 611 and the water outlet portion 612 does not leak to the outside and passes across the head 60.

In other words, water introducing into the head 60 passes through the head 60 without passing through the filter 40, and even in a state where the filter 40 is separated, water does not leak from a side on which the filter 40 is mounted and can be continuously supplied to the water supplying flow path 30.

On the other hand, a flow path projecting portion 963 which projects for forming the filtering flow path 96 (described in more detail below) is formed on the inner surface of the bypass flow path 95. The flow path projecting portion 963 may be formed at the center of the inside portion of the shaft 90 and project from the bottom of the bypass flow path 95 but may be formed not to shield the bypass flow path 95.

Both ends of the flow path projecting portion 963 may be inclined or rounded so that a decrease in the flow velocity caused by the flow path projecting portion 963 can be minimized when water flows through the bypass flow path 95.

FIG. 28 illustrates a longitudinal section in a state where the filtering flow path is shifted to be connected with the water inlet portion and the water outlet portion. As shown, the filtering flow path 96 may be connected to the water inlet portion 611 and the water outlet portion 612 according to the rotation of the shaft 90.

At this time, the shaft inlet port 961 and the shaft outlet port 962 are in contact with the water inlet port 611a and the water outlet port 612a, respectively. and the outsides of the shaft inlet port 961 and the shaft outlet port 962 and the outsides of the water inlet port 611a and the water outlet port 612a are capable of being fully sealed by the sealing member 94. An inner pipe 97 may be formed on the inside of the lower part 92, and the inner pipe 97 can be connected to the supporter extending portion 85.

Accordingly, the water which flows into through the shaft 90 can be supplied to the inside portion of the filter 40 through the upper supporter 80 and discharged to the shaft 90 through the upper supporter 80 after the water is purified by the filtering member 44. In other words, the water which flows into the head 60 can be purified through the filter 40 and then discharged through the head 60.

On the other hand, the filtering flow path 96 may include a shaft water inlet flow path 964 and a shaft water outlet flow path 965.

The shaft water inlet flow path 964 may include a horizontal portion 964a that extends from the shaft inlet port 961 to the center of the shaft 90 and a vertical portion 964b that extends from an end portion of the vertical portion 964a in the lower direction. The vertical portion 964b may be formed by the inner pipe 97.

The outer surface of the inner pipe 97 may be spaced apart from the inner surface of the lower part 92 to form a spacing space 971. The distance of the spacing space 971 may correspond to the thickness of the supporter extending portion 85. Therefore, when the filter 40 is mounted, the upper end of the supporter extending portion 85 can be inserted into an inside of the spacing space 971.

The length of the inner pipe 97 in the vertical direction may be shorter than the length of the outer surface of the lower part 92 in the vertical direction. The inner pipe 97 and the supporter extending portion 85 may be connected together on the inner surface of the lower part 92. To this end, a second connecting portion 972 may be formed on the lower end of the inner pipe 97.

The second connecting portion 972 may have a shape corresponding to the first connecting portion 851. The second connecting portion 972 may be inserted into the first connecting portion 851 so that the shaft 90 and the upper supporter 80 can be rotated together.

The shaft water inlet flow path 964 may communicate with the filter inlet flow path 871. The water for purification can be supplied to the filtering member 44 by the coupling together the inner pipe 97 and the supporter extending portion 85.

The shaft water outlet flow path 965 may include a water outlet guide portion 965b formed on an outer surface of the lower part 92, and a water outlet connecting portion 965a formed on the upper part 91.

The upper end of the water outlet guide portion 965b may pass through the lower surface of the upper part 91 and then communicate with the water outlet connecting portion 965a. The water outlet connecting portion 965a may connect the water outlet guide portion 965b and the shaft outlet port 962 at the inside of the upper part 91.

Accordingly, the purified water which is discharged from the filter outlet port 862 can move along the water guide portion 965b in the upper direction and be discharged to the shaft outlet port 962 through the water outlet connecting portion 965a. The purified water which is discharged to the shaft outlet port 962 may be discharged through the water outlet portion 612.

Accordingly, for example, in a state where the filtering flow path 96 is connected to the water inlet portion 611 and the water outlet portion 612, the water which flows into the head 60 through the water inlet pipe 301 is supplied into the inside portion of the filter 40 and then is capable of being purified, and may flow again from the filter 40 to the head 60 and be discharged to the water outlet pipe 302.

On the other hand, the body seating portion 65 may be formed on the inner circumferential surface of the upper body 64. The lower surface of the upper part 91 may be seated on the body seating portion 65 when the shaft 90 is mounted.

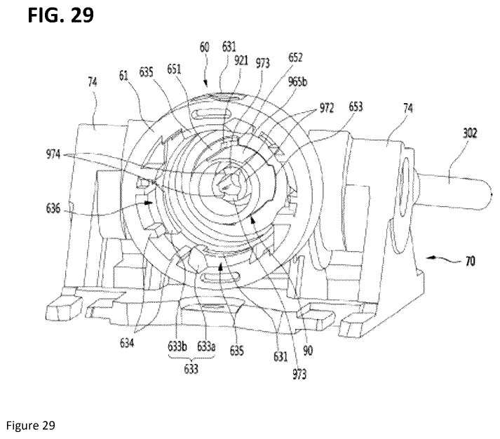

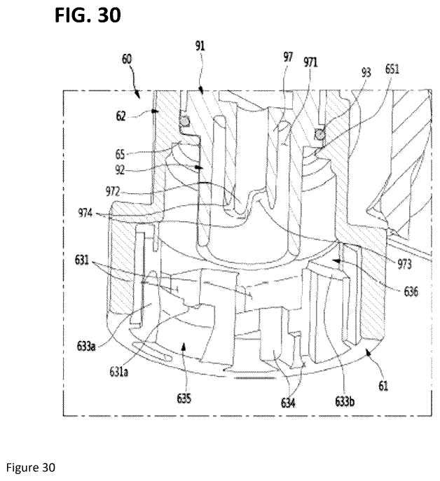

FIG. 29 is a perspective view illustrating the head viewed from below. FIG. 30 is a partially cutaway perspective view illustrating the head.

With reference to FIGS. 27-30, a rotating guide 651 may be formed on the body seating portion 65. The rotating projection 921 may be positioned on an inside of the rotating guide 651. The rotating guide 651 may be formed on the body by cutting the body at an angle of 180 degrees with respect to the center of the head body 61. However, it is not limited thereto.

Since a pair of rotating projections 921 are disposed at an angle of 90 degrees, in a case where the shaft 90 may be rotated by the angle of 90 degrees, the rotating projections 921 is capable of being stopped by stoppers 652 which are formed on both ends of the rotating guide 651.

The water inlet portion 611 and the water outlet portion 612 may be selectively connected to the filtering flow path 96 or the bypass flow path 95 at a position which is stopped by the stopper 652. Therefore, when the user rotates the filter 40 to a point where the filter 40 is no longer rotated in one direction even without rotating the filter 40, the flow path is capable of being selected and accurately connected.

A flow path cutout portion 653 may be formed on one side of the body seating portion 65. The flow path cutout portion 653 may be formed on the seating portion 65 in a position facing the rotating guide 651 and may be formed on the lower side of the water outlet port 612a in the vertical direction.

Therefore, the flow path cutout portion 653 may be disposed at a position which is the same as that of the water outlet guide portion 965b in a state where the shaft 90 is rotated so that the filtering flow path 96 is connected to the water inlet portion 611 and the water outlet portion 612. The flow path cutout portion 653 may have the same (or substantially the same) width as the water outlet guide portion 965b. Therefore, the water outlet guide portion 965b and the flow path cutout portion 653 can be in contact with each other to form a flow path through which the purified water is capable of flowing in the upper direction.

On the other hand, a pair of the coupling grooves 631 and a plurality of the supporting ribs 634 may be formed on the inner surface of the lower body 63. When the filter 40 is mounted on the head 60 and then rotated so that the filtering flow path 96 is connected to the water inlet portion 611 and the water outlet portion 612, the coupling projection 433 can be inserted into the coupling groove 631.

The coupling groove 631 may be exposed to the outside portion through the opening portion 632, and the coupling state of the restraining projection 433b and the restraining groove 531a can be checked through the opening portion 632. The position of the restraining groove 631a may be formed at a position in which the restraining projection 433b and the restraining groove 631a may be engaged to be restrained with each other in a state where the coupling projection 433 is fully rotated. Therefore, in a state where the filter 40 is inserted into the inside of the head 60 and then fully rotated, the coupling projection 433 is capable of being restrained in the inside of the coupling groove 631 and thus random separation of the filter can be prevented.

On the other hand, the coupling groove 631 may be formed by a first guide projecting portion 635 which projects from the inner surface of the lower body 63. The restraining groove 631a may be formed on the upper surface of the first guide projecting portion 635. The first guide projecting portion 635 may be formed from the opened end of the lower body 63 to the coupling groove 631 and provide a surface on which the coupling projection 433 can be seated.

Therefore, when the filter 40 is inserted into the head 60, the coupling projection 433 cannot be inserted into some sections of the opening of the lower surface of the head 60 due to the interference of the first guide projecting portion 635. The coupling projection 433 can be inserted through the section which is not interfered with the first guide projecting portion 635, so that the filter 40 can be prevented from being erroneously mounted.

A first groove guide portion 633a for guiding the coupling projection 433 to the entrance of the adjacent coupling groove 631 may be formed on one side surface of the first guide projecting portion 635. The first groove guide portion 633a may have a predetermined inclination and be in contact with the projection guide portion 433a of the coupling projection 433 and thus guide the rotational movement of the coupling projection 433 in one direction when the coupling projection 433 is inserted.

A second guide projecting portion 636 may be formed on one side which is spaced apart from the end portion of the first groove guide portion 633a along the inner surface of the lower body 63 by a predetermined distance. A second groove guide portion 633b may be inclined on the second guide projecting portion 636 so that the coupling projection 433 which passes by the first groove guide portion 633a moves along the second groove guide portion 633b so as to be guided and moved to the entrance of the coupling groove 631. The second groove guide portion 633b may extend from one side away from the first groove guide portion 633a to the entrance of the coupling groove 631.

Therefore, when the filter 40 is inserted into the opened lower surface of the lower body 63 after the coupling projection 433 is positioned at a position corresponding to the inserting display portion 613 when the filter 40 is mounted, the projection guide portion 433a slides along the first groove guide portion 633a and then slides along the second groove guide portion 633b and is inserted into the inside of the coupling groove 631.

In a case where the user inserts the coupling projection 433 of the filter 40 by aligning the coupling projection 433 in a process of the filter 40 being inserted into the inside of the head 60, the filter 40 can be coupled while being smoothly rotated by the first groove guide portion 633a and the second groove guide portion 633b.

The shaft 90 and the upper supporter 80 are integrally coupled together in a state where the filter 40 is fully inserted and then the coupling projection 433 is positioned at the entrance of the coupling groove 631. When the filter 40 is further rotated so that the coupling projection 433 is fully inserted into the inside of the coupling groove 631, the shaft 90 is rotated together with the filter 40 and the filtering flow path 96 is rotated to be connected to the water inlet portion 611 and the water outlet portion 612.

To this end, a second connecting portion 972 may be formed at the lower end of the shaft 90, that is, at the lower end of the inner pipe 97. A pair of second connecting portions 972 may have the same shape at a position which faces each other, and both sides of the lower end of the inner pipe 97 may be formed by a cutting operation. However, it is not limited to thereto.

Specifically, the lower end of the inner pipe 97 may include the pair of second connecting portions 972 and a pair of pipe cutout portions 973 formed between the second connecting portions 972. The pair of second connecting portions 972 may have a width which is gradually narrowed in the lower direction.

A second inclined surface 974 may be formed at both side ends of the pair of second connecting portions 972 and the second inclined surface 974 may be formed to have an inclination corresponding to the first inclined surface 853.

The second inclined surface 974 may be inserted along the first inclined surface 853 in a process of the filter 40 being rotatably inserted into the head 60. When the filter 40 is fully inserted into the head 60, the second connecting portion 972 may be matched with the first connecting portion 851 and the projecting portion 852 may be matched with the pipe cutoff portion 973. Therefore, the first inclined surface 853 and the second inclined surface 974 can be in close contact with each other.

In addition, the second inclined surface 974 may be inclined in the direction of rotation of the filter 40 as the first inclined surface 853. Therefore, when the filter 40 is further rotated in a state where the rotation of the shaft 90 is restricted by the stopper 652, the force in the rotating direction is acted to the second inclined surface 974 and the first inclined surface 853 and the first inclined surface 853 moves along the second inclined surface 974 so that the filter 40 can be more easily separated.

It should be appreciated that the head described with respect to FIGS. 24-30 can be modified in any one of a number of ways to accommodate the filters of one or more embodiments shown and described herein. As but one example, the second inclined surface 972 can be removed when the filter does not include a corresponding first inclined surface 853. As another example, the particular shapes and configurations of features configured to couple with one or more features of the filter may be modified depending on the particular embodiment of the filter for use with the head.

On the other hand, a plurality of the supporting ribs 634 may be formed on the inner surface of the lower body 63, and the outer surface of the filter inserting portion 431 can be supported by the supporting ribs 634.

Hereinafter, the operation of the water purifying apparatus according to an embodiment of the invention having the structure described above is described.

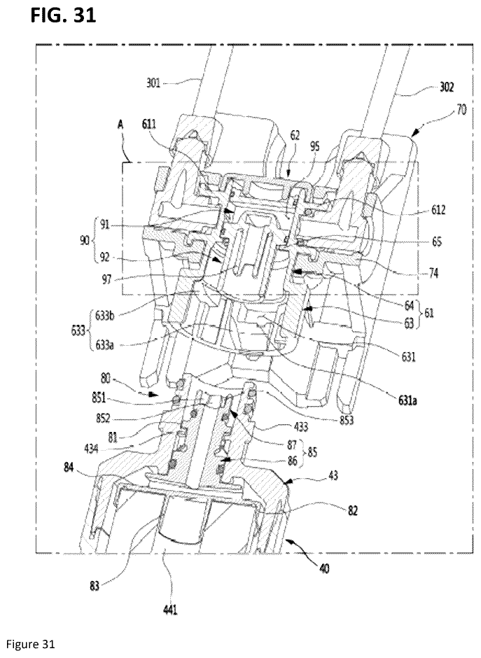

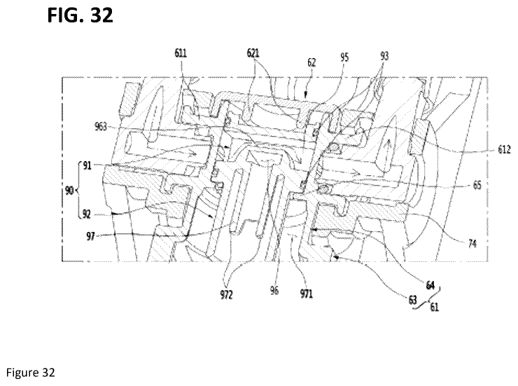

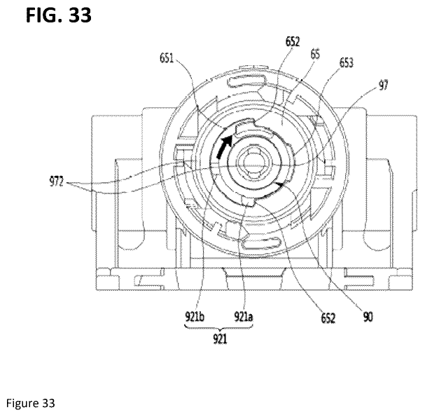

FIG. 31 is a cutaway perspective view illustrating a state where of the filter and the head are separated from each other according to an embodiment of the invention. FIG. 32 is an enlarged view of portion A of FIG. 31, and FIG. 33 is a view illustrating a shaft position in a state where the filter and the head are separated from each other. It should be appreciated that the following description is provided as an example, and modifications may be in accordance with the filters shown and described in the various embodiments herein. For example, where a description of a particular water flow path is described, it should be appreciated that one or more modifications can be made to the flow path to enable the use of a filter having an alternative flow path, as described herein.

As illustrated in the drawings, the bypass flow path 95 may be connected to the water inlet portion 611 and the water outlet portion 612 in a state where the filter 40 is not coupled to the head 60.

Therefore, the water which flows into through the water inlet portion 611 flows into the bypass inlet port 951 through the water inlet port 611a and flows along the bypass flow path 95. The water is discharged to the water outlet portion 612 through the bypass outlet port 952 and the water outlet port 612a. In other words, the water which flows into the water inlet portion 611 passes through the head 60 without being subjected to a purification process, and is supplied directly to the ice maker 24 or the dispenser 23 through the water supplying flow path 30.

Such a state may correspond to a state where the filter 40 is separated for replacement of the filter 40, or may correspond to a situation where the service which is related to the cleaning of a pipeline or other maintenance is performed. In addition, even in a case where at least a portion of the plurality of filters 40 are not used, or where purification of water is not required, it is capable of corresponding to such a state. Moreover, even in a case where the filter 40 is fully separated, no problem occurs in use of the refrigerator 1.

On the other hand, with reference to FIG. 33, when the disposition of the shaft 90 is described in a state where the filter 40 is not mounted, the first rotating projection 921a of the pair of rotating projections 921 is in a state of being in contact with the stopper 652 of one side of the rotating guide 651. In this state, the water outlet guide portion 965b and the flow path cutout portion 653 are maintained a state of being shifted by an angle of about 90 degrees with each other.

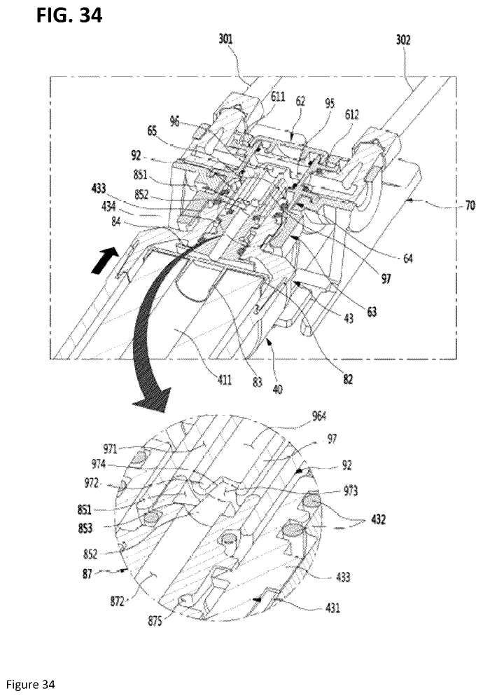

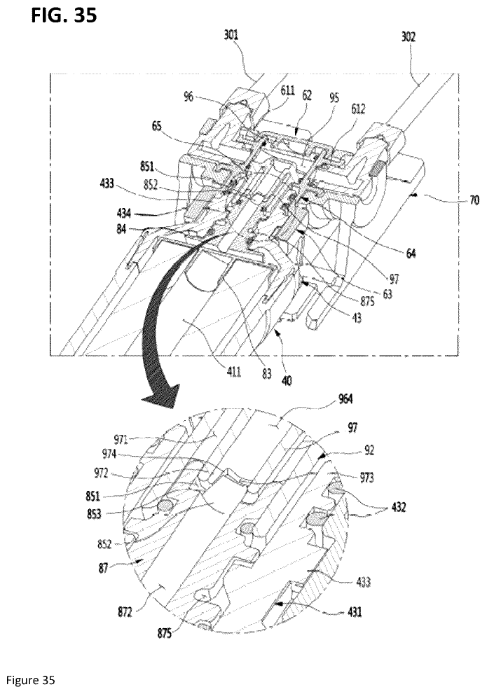

FIG. 34 is a view illustrating a state where the filter is inserted into an inside of the head. FIG. 35 is a view illustrating a state where the filter is fully inserted into the inside of the head.

As illustrated in the drawings, the filter inserting portion 431 is inserted into the opening of the lower surface of the head 60 to mount the filter 40. At this time, the position of the coupling projection 433 is capable of being aligned and inserted by referring to the inserting display portion 613 formed on the outside of the head 60.

The coupling projection 433 slides along the first groove guide 633a and the second groove guide 633b in a process of the insertion of the filter 40. Accordingly, the filter 40 can be smoothly rotated along with insertion.

When the filter 40 is inserted by a predetermined depth, the insertion of the second connecting portion 972 into the inside of the first connecting portion 851 proceeds, as illustrated in FIG. 33. At this time, the second connecting portion 972 and the first connecting portion 851 are capable of being slid while the second inclined surface 974 and the first inclined surface 853 are in contact with each other, respectively. Accordingly, the second connecting portion 972 may be guided to the inside of the first connecting portion 851.

In other words, when the filter 40 is inserted and mounted, the filter 40 is smoothly rotated in the process of inserting the filter 40 into the head 60 by the first groove guide 633a and the second groove guide 633b. The shaft 90 and the supporter extending portion 85 can be fully matched by sliding the second inclined surface 974 and the first inclined surface 853 in the process of rotation, as illustrated in FIG. 35.

As illustrated in FIG. 35, the coupling projections 433 may be located on the inner side or the entrance side of the coupling grooves 631 in a case where the shaft 90 and the supporter extending portion 85 are fully matched with each other. In other words, the filter 40 corresponds to a state where the filter 40 is simply inserted before the filter 40 is fully coupled with the head. In this state, the shaft 90 is not rotated, and the bypass flow path 95 is in a state of being connected to the water inlet portion 611 and the water outlet portion 612.

Moreover, in the state illustrated in FIG. 35, the user is capable of further rotating the filter 40 in the rotation advancing direction and is rotated by about 90 degrees so that the coupling projection 433 is fully inserted into the inside of the coupling groove 631.

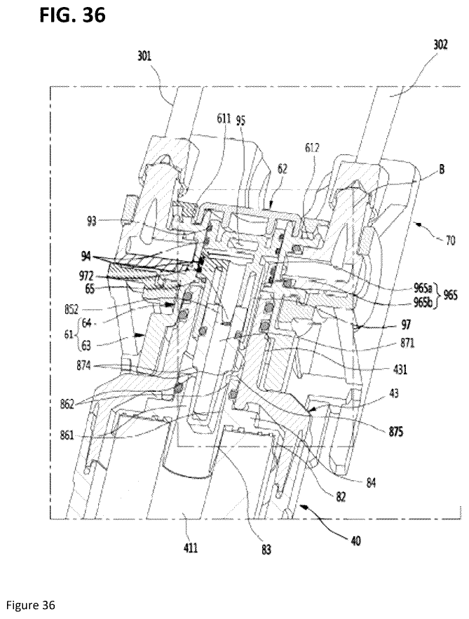

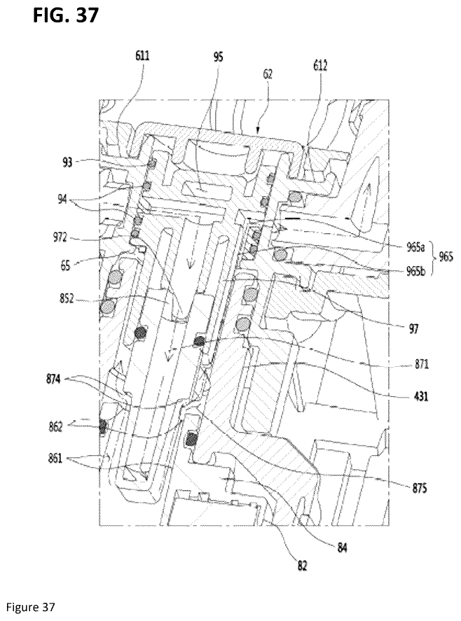

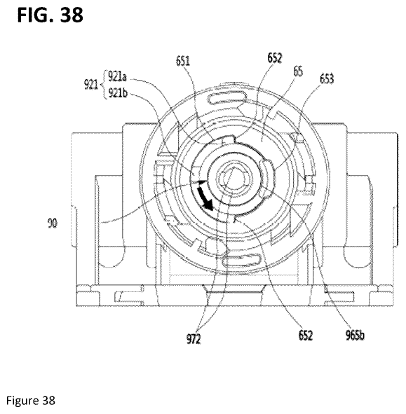

FIG. 36 is a view illustrating a state where the filter is rotated for coupling in a state where the filter is fully inserted into the inside of the head. FIG. 37 is an enlarged view of portion B in FIG. 36, and FIG. 38 is a view illustrating a shaft position in a state where the filter is coupled to the head.

In FIG. 35, when the filter 40 is further rotated by an angle of 90 degrees so that the coupling projection 433 and the coupling groove 631 are rotated to be fully coupled with each other, the shaft 90 is also rotated along with the rotation of the filter and thus is in a configuration as illustrated in FIG. 38.

Specifically, when the filter 40 is rotated in a state where the second connecting portion 972 is inserted into the first connecting portion 851 and thus fully coupled together, the shaft 90 rotates along with the filter 40.

The shaft 90 may be further rotated by an angle of about 90 degrees until the second rotating projection 921b reaches the position of the stopper 652. When the shaft 90 is fully rotated, the filtering flow path 96 is connected to the water inlet portion 611 and the water outlet portion 612. Of course, the inner pipe 97 and the supporter extending portion 85 maintains a connected state with each other and thus the original water and the purified water is capable of flowing in and out between the head 60 and the filter 40. In addition, the coupling projection 433 is in a state of being fully inserted into and thus is coupled with the coupling groove 631 and the filter 40 is operated to be rotated in a direction which is opposite to the coupling direction by the user and thus the filter 40 is maintained in a state of coupling with the head 40 until the filter 40 is separated from the head 60.

Moreover, in FIG. 36, the water flowing in through the water inlet portion 611 flows along the shaft water inlet flow path 964 through the water inlet port 611a and the shaft inlet port 961. In other words, water flowing along the horizontal portion 964a and the vertical portion 964b passes by the inner pipe 97, flows into the inside of the supporter extending portion 85 and flows along the first filter inlet flow path 872 in the lower direction. Then, water is branched by the second filter inlet flow path 873 and flows into the space between the inner surface of the housing 41 and the filtering member 44.

The water flowing into the hollow 441 of the inside of the filtering member 44 from the outside of the filtering member 44 may be purified in the process of passing through the filtering member 44. The purified water of the inside of the filtering member 44 flows along the inside of the first extending portion 86 in the upper direction and is discharged from the filter outlet port 862 which is disposed on both sides of the upper end of the first extending portion 86 in the upper direction.

At this time, a space in which water purified by the outer surface of the first extending portion 86 and the lower part 92 inserted into the inside of the filter inserting portion 431 flows to the head 60 side may be formed in the inside of the filter inserting portion 431. On the other hand, as illustrated in FIG. 36, where the filtering flow path 96 is connected to the water inlet portion 611 and the water outlet portion 612, the water outlet guide portion 965b and the flow path cutout portion 653 are positioned at the same position with each other and thus the purified water is capable of flowing to the upper part 91 side.

Accordingly, the purified water flows along the water outlet guide portion 965b formed in the lower part 92 in the upper direction and flows into the inside of the upper part 91 and thus passes through the shaft outlet port 962 and the water outlet portion 612 in this order, and then is discharged to the water outlet portion 612. The water outlet pipe 302 of the water outlet portion 512 forms a portion of the water supplying flow path 30 to supply the purified water to the dispenser 23 and the ice maker 24.

Moreover, as illustrated in FIG. 35, in a state where the filter 40 should be removed because of reach of period of replacement of the filter 40 or other maintenance, the filter 40 is first rotated in a direction which is opposite to the coupling direction.

The coupling projection 433 may be moved in a direction away from the coupling groove 631 according to the rotation of the filter 40 and the supporter extending portion 85 rotates the shaft 90. As illustrated in FIG. 32, when the filtering flow path 96 is closed by the shaft 90 being rotated by 90 degrees and then the bypass flow path 95 is connected, the rotating projection 921 contacts the stopper 652 and thus is restricted the rotation of the shaft 90.

In this state, when a force is applied to further rotate the filter 40, the shaft 90 cannot be further rotated based on interference with the stopper 652. Accordingly, a torsion moment is applied to the first inclined surface 853 and the second inclined surface 974 so that the second inclined surface 974 is smoothly separated along the first inclined surface 853 while being slid. Further, the coupling projection 433 which is escaped from the coupling groove 631 passes by the second groove guide portion 633b and the first groove guide portion 633a in this order to allow the filter 40 to be separated from the head 60.

In the disclosed embodiments of the invention, so as to facilitate the understanding of the invention, as an example, the water purifying apparatus 17 is described as being mounted on the refrigerator 1. However, it is understood that the water purifying apparatus 17 described herein can likewise be applied to the water purifier which is generally used and the entire device which is capable of purifying water by a filter exchanging manner.

The water purifying apparatus according to the disclosed embodiments and the refrigerator including the water purifying apparatus have at least the following effects.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

1. A refrigerator having a manifold for a water filter positioned in an interior of the refrigerator, the manifold comprising:
a shaft;
a tube inside the shaft, the tube having a wall, a distal end, and a proximal end, the distal end of the tube having at least a distal wall portion that is positioned farther away from the proximal end than another second wall portion; and
a bridge extending toward an inside of the tube from the distal wall portion, the bridge being present at the midpoint of the distance between a point on the distal wall portion of the tube and an opposite wall.

2. A refrigerator having a manifold for a water filter positioned in an interior of the refrigerator, the manifold comprising:
a shaft;
a tube inside the shaft, the tube having a wall, a distal end, and a proximal end, the distal end of the tube having a plurality of distal wall portions that are positioned farther away from the proximal end than a plurality of intermediate wall portions; and
a bridge extending toward an inside of the tube from one of the plurality of distal wall portions, the bridge being present at the midpoint of the distance between the one distal wall portion of the tube and an opposite other one of the plurality of distal wall portions of the tube.

3. The refrigerator having a manifold for a water filter positioned in an interior of the refrigerator according to claim 2, wherein the bridge extends toward the inside of the tube from the one of the plurality of distal wall portions along the length of the tube.

4. The refrigerator having a manifold for a water filter positioned in an interior of the refrigerator according to claim 2, wherein the bridge extends toward an inside of the tube from one of the plurality of distal wall portions to another of the plurality of distal wall portions.

5. The refrigerator having a manifold for a water filter positioned in an interior of the refrigerator according to claim 3, wherein the bridge extends toward the inside of the tube from the one of the plurality of distal wall portions to the other of the plurality of distal wall portions along the length of the tube.

6. The refrigerator having a manifold for a water filter positioned in an interior of the refrigerator according to claim 2,
wherein the plurality of distal wall portions comprises first and second distal wall portions positioned across from each other, with the intermediate wall portions positioned therebetween, and
further wherein the bridge extends toward an inside of the tube from the first distal wall portion, across the inside of the tube, and to the second distal wall portion.

7. The refrigerator having a manifold for a water filter positioned in an interior of the refrigerator according to claim 6, wherein the bridge extends toward the inside of the tube from the first distal wall portion, across the inside of the tube, and to the second distal wall portion along the length of the tube.

8. The refrigerator having a manifold for a water filter positioned in an interior of the refrigerator according to claim 2,
wherein the plurality of distal wall portions comprises first and second distal wall portions positioned across from each other, with the intermediate wall portions positioned therebetween, and
further wherein the bridge extends toward an inside of the tube from the first distal wall portion, across the inside of the tube, and toward the second distal wall portion; and
further wherein the bridge extends toward an inside of the tube from the second distal wall portion, across the inside of the tube, and toward the first distal wall portion.

9. The refrigerator having a manifold for a water filter positioned in an interior of the refrigerator according to claim 8, wherein the bridge extends toward the inside of the tube from the first distal wall portion, across the inside of the tube, and toward the second distal wall portion along the length of the tube.

10. A manifold for a water filter, the manifold comprising:
a shaft;
a tube inside the shaft, the tube having a wall, a distal end, and a proximal end; and
a projection extending distally toward the distal end of the tube, the projection being present at the midpoint of the distance between a point on the tube and an opposite wall.

11. The manifold for a water filter according to claim 10, wherein the projection extends from one side of the tube to the other side of the tube with a gap between the central longitudinal axis of the projection and the tube.

12. The manifold for a water filter according to claim 10, wherein the projection also extends laterally toward a point on the distal wall portion of the tube.

13. The manifold for a water filter according to claim 11, wherein the projection also extends laterally from a point on the distal wall portion of the tube to another point on the distal wall portion of the tube.

14. The manifold for a water filter according to claim 10, wherein the projection extends distally from a proximal wall of the manifold toward the distal end of the tube, the projection being present at the midpoint of the distance between the point on the tube and an opposite wall.

15. The manifold for a water filter according to claim 11, wherein the projection extends distally from a proximal wall of the manifold toward the distal end of the tube, the projection being present at the midpoint of the distance between a point on the distal wall portion of the tube and an opposite wall.

16. A manifold for a water filter, the manifold comprising:
a shaft;
a tube inside the shaft and having a central longitudinal axis; and
a piece extending into the tube to prevent a component of a filter from entering a point of the region of the tube's central longitudinal axis.

17. The manifold for a water filter according to claim 16, wherein the piece extends from one side of the tube to the other side of the tube with a first gap at the midpoint of the bridge and the tube, and the first gap is configured to prevent a component of a filter from entering into it.

18. The manifold for a water filter according to claim 17, the first gap having a minimum dimension to prevent a component of a filter from entering into the first gap.

19. The manifold for a water filter according to claim 16, wherein the tube has a wall, a distal end, and a proximal end, the distal end of the tube having at least a distal wall portion that is positioned farther away from the proximal end than another second wall portion, and the piece extends toward the inside of the tube from the distal wall portions along the length of the tube.
